(19) United States
(12) Patent Application Publication
(10) Pub. No.: US 2018/0014509 A1
(43) Pub. Date: Jan. 18, 2018

(54) TOILET FOR PET DOGS

(71) Applicant: Jin Ho KWAK, Seoul (KR)

(72) Inventor: Jin Ho KWAK, Seoul (KR)

(21) Appl. No.: 15/538,758

(22) PCT Filed: Dec. 9, 2015
(86) PCT No.: PCT/KR2015/013426

§ 371 Date: Jun. 22, 2017

(30) Foreign Application Priority Data
Dec. 22, 2014 (KR) 10-2014-0186457
Mar. 20, 2015 (KR) 10-2015-0039246

(51) Int. Cl. A01K 23/00; A01K 1/01

(52) U.S. Cl. CPC A01K 23/005; A01K 1/0114; A01K 1/0117

(57) ABSTRACT

Disclosed is a toilet for pet dogs. The toilet for pet dogs according to the present invention comprises: a bottom unit having a receiving space; an isolation container unit inserted in the receiving space; a conveyor unit which is installed on the top of the bottom unit, the conveyor unit comprising a net-type belt, a driving roller and a driven roller on which the net-type belt is wound, and a cleaning roller for cleaning the net-type belt; and a top unit comprising a cleaning chamber cover positioned at the top of the cleaning roller, a nozzle installed at the ceiling of the cleaning chamber cover, and a fan for forcible drying. According to the present invention, it is possible to automatically clean the toilet for pet dogs more cleanly, and effectively prevent propagation of germs or generation of odor. Also, it is possible to assemble the toilet for pet dogs more firmly. In addition, it is possible to further facilitate disassembly and assembly of the toilet for pet dogs and tension-control of the net-type belt.

### TECHNICAL FIELD

The present invention relates to a toilet for pet dogs, and more particularly, to a toilet for pet dogs capable of more cleanly cleaning excrement of the pet dogs and efficiently preventing propagation of germs or generation of odor through drying and sterilizing.

### BACKGROUND ART

One of the most uncomfortable and troublesome things for those who raise pet dogs indoors is to clean up excrement. Even if the pet dog is trained to observe the place and time of excretion, it is not inconvenient for a person to remove the excrement whenever it is generated.

Because of the inconvenience, people are using a variety of products designed to make it easier to dispose of their pet dog's excrement.

The most commonly used product is a disposable excretion pad that has a urine absorbing function. Since the pad may be replaced with new pads when the pet dog excrete on the disposable excretion pad while the disposable excretion pad is laid out at a certain position in the room, a user need not clean a floor, and as a result, it is convenient to use the disposable excretion pad.

However, the disposable excretion pad has a disadvantage in that when the user does not remove the excrement promptly after excretion, not only a smell spreads but also the excrement gets on a feet of the pet dog that run around may contaminate the room. Further, when urine is repeatedly used even if the urine is passed, unabsorbed urine stagnates on the top of the pad or flows out to cause indoor pollution. In addition, the use of the disposable excretion pad is contrary to a recent social trend to reduce the use of disposable products in order to waste resources and prevent environmental pollution.

As a result, more and more people have used a toilet for the pet dog that may be used repeatedly, rather than the disposable products, and various types of toilets for the pet dogs have been introduced.

The simplest type of toilet for the pet dog is a toilet with a plurality of through holes formed at the top of a box-shaped toilet bowl. When the pet dog is excreted, the urine flows down to the toilet bowl through a through-hole of an excretion plate and the excrement is laid on the top of the excretion plate.

However, such a toilet for the pet dog does not immediately clean the excretion plate on which the excrement is placed, the smell spreads and thereafter, the excrement gets on the pet dog's feet put on the excretion plate, and as a result, the room may be contaminated and an odor may be generated due to the urine which stagnates in a toilet bowl.

Unlike this, there is a type having an automatic cleaning function as introduced in Patent 1 (Korean Patent Registration No. 10-1157038) and Patent 2 (Korean Patent Registration No. 10-1268177).

A toilet for a pet dog according to Patent 1 includes a conveyor type excretion belt and water spray nozzles provided at one side and a lower side of the excretion belt, and has a function to automatically clean the excretion belt by interworking with a boarding sensor and an excretion sensor.

This scheme has the advantage in that the user need not clean the excretion one by one, but has the disadvantage in that there is no through-hole in the excretion belt, and as a result, the urine easily gets on the feet of the pet dog and it is difficult to cleanly clean the excretion belt only by means of the water spray nozzle and water is excessively used for perfect cleaning.

In particular, according to Patent 1, there is the disadvantage that piping connection is complicated and it is difficult to select an installation site at will because it is necessary to connect a water pipe and a drain port, and there is the disadvantage that it is difficult to change the installation site once the toilet is installed.

The toilet for the pet dog according to Patent 2, which is proposed by the present applicant, includes a net-type conveyor including the through-hole and a cleaning roller installed at one side of the conveyor and simultaneously performing friction cleaning and water cleaning in contact with the surface of the conveyor and in particular, includes a water supply container storing the water and an excrement isolation container storing the excrement.

According to Patent 2, since the urine of the pet dog flows down through the through-hole of the net-type conveyor, it is possible to prevent the urine from getting on the feet of the pet dog. Further, since the water pipe or the drain port need not be connected, installation operation is not required. and transportation and movement are easy, it is convenient to change the installation site.

However, since the toilet according to Patent 2 adopts the net-type conveyor, it is necessary to more cleanly clean the excrement which gets on a load supporter positioned at a lower part of the net-type conveyor or a corner portion of a drain plate. Further, since such a scheme is a scheme in which the excrement is not immediately discharged but stored in the isolation container, it is necessary to prevent generation of germs and generation of the odor. Moreover, since such a scheme is a water cleaning scheme, it is also necessary to prevent the generation of the germs and the generation of the odor due to moisture. In addition, it is necessary to more facilitate disassembly and assembly and tension control of the net-type conveyor. Further, it is necessary to dispose of the excrement filled in the isolation container more safely.

Meanwhile, since the toilet for the pet dog of Patent Documents 1 and 2 may not consider a habit of a male dog that passes the urine with lifting one leg, the toilet for the pet dog has the disadvantage that it is difficult to prevent the urine from flowing out when the pet dog urinates with lifting one leg.

### DISCLOSURE

### Technical Problem

The present invention is contrived from such a background and an object of the present invention is to automatically clean a toilet for a pet dog more clearly and effectively prevent generation of germs and generation of an odor.

Further, an object of the present invention is to automatically clean a net-type conveyor more clearly and more cleanly and effectively collect cleaning water.

In addition, an object of the present invention is to more firmly assemble each unit at the time of assembling and installing the toilet for the pet dog. Further, an object of the present invention is to more easily move the toilet for the pet dog.

Moreover, an object of the present invention is to more facilitate disassembly and assembly and tension control of the net-type conveyor. Further, an object of the present invention is to dispose of excrement filled in an excrement isolation container more safely.

In addition, an object of the present invention is to induce a male dog to more safely pass urine by considering a habit of the male dog and appropriately clean the urine.

### Technical Solution

An aspect of the present invention provides a toilet for pet dogs comprising: a bottom unit having a receiving space opened to one side and formed between the bottom and a drain plate; an isolation container unit which is inserted to the receiving space and has a storage space and an inlet opened upward; a conveyor unit installed on the drain plate of the bottom unit, wherein the conveyor unit has a net-type belt on which the pet dog rides, a driving roller and a driven roller on which the net-type belt is wound, and a cleaning roller installed at one side of the driving roller to clean the net-type belt; and a top unit mounted on the bottom unit to expose the net-type belt, wherein the top unit has a opening portion to expose the net-type belt, a cleaning chamber cover positioned at the top of the cleaning roller, a nozzle installed at the ceiling of the cleaning chamber cover to spray water, and a fan supplying air to an inner space of the cleaning chamber cover for forcible drying.

In the toilet for pet dogs according to an aspect of the present invention, the top unit includes an isolation container cover opening and closing the inlet of the isolation container unit and a sterilizing lamp installed in the isolation container cover.

In the toilet for pet dogs according to an aspect of the present invention, the bottom unit includes a water collecting wall formed at one side of the drain plate and the water collecting wall includes a curved portion surrounding one side of the driven roller and having same curvature of the driven roller.

In the toilet for pet dogs according to an aspect of the present invention, the bottom unit includes conveyor mounting plates that protrude toward the upside of the drain plate at inner walls facing each other with the drain plate interposed therebetween, respectively, and a nozzle that sprays water to the bottom of the conveyor mounting plate.

In the toilet for pet dogs according to an aspect of the present invention, the bottom unit includes a water collecting wall formed at one side of the drain plate and the water collecting wall has a sterilizing lamp that irradiates light to the upside of the drain plate.

In the toilet for pet dogs according to an aspect of the present invention, the conveyor unit includes a load supporter supporting the net-type belt and a load supporter cleaning means cleaning the load supporter.

In the toilet for pet dogs according to an aspect of the present invention, the conveyor unit includes a load supporter supporting the net-type belt and a nozzle installed in the load supporter to spray water between the driven roller and the net-type belt.

In the toilet for pet dogs according to an aspect of the present invention, a urine guide unit is formed to protrude upward at one side of the opening portion of the top unit.

In this case, the urine guide unit may include a water collecting portion in which the water supplied from the water supply pipe is collected, a urination plate formed toward the net-type belt at one side, water barrier plates formed at both sides of the urination plate and protruding forward the urination plate, and an outlet formed in the urination plate. to discharge water of the water collecting portion. And, the urine guide unit includes an ascending passage of which a lower end communicates with the water collecting portion and an upper end is positioned above the outlet and a descending passage connecting the upper end of the ascending passage and the outlet, and the water of the water collecting portion is discharged to the urination plate by a Siphon principle.

Another aspect of the present invention provides a toilet for pet dogs comprising: a bottom unit having a receiving space opened to one side and formed between the bottom and a drain plate; an isolation container unit which is inserted to the receiving space and has a storage space and an inlet opened upward; a conveyor unit installed on the drain plate of the bottom unit and having a net-type belt on which the pet dog rides; and a top unit mounted on the bottom unit to expose the net-type belt, wherein the top unit has an inlet for entrance of the isolation container unit at one side and a pair of isolation container locking members installed rotatably based on vertical shafts at both sides of the inlet.

In the toilet for pet dogs according to another aspect of the present invention, the pair of isolation container locking members may include connection means which are formed at the inner side adjacent to the vertical shaft, respectively, to be connected to the inner wall of the bottom unit.

In the toilet for pet dogs according to another aspect of the present invention, the toilet for pet dogs comprises a pair of side cover one end of which is connected to the pair of the isolation container locking members, respectively, and each side cover includes a cutout portion formed in a horizontal direction from the other end and a grip portion which protrudes from the outside of the side cover to the outside of the cutout portion and has a receiving groove to which a grip of the isolation container unit is inserted at the inner side.

In the toilet for pet dogs according to another aspect of the present invention, in the pair of isolation container locking members, a separation prevention projection is formed at the edge of the inner side positioned at the opposite side to the vertical shaft, and the separation prevention projection is inserted between an inner wall of the bottom unit and an outer wall of the isolation container unit when the isolation container locking member is connected to the inner wall of the bottom unit.

In the toilet for pet dogs according to another aspect of the present invention, the pair of isolation container locking members includes stoppers protruding downward at the outer side adjacent to the vertical shaft, respectively, and the stopper is in contact with the outer end of the bottom of the bottom unit when the isolation container locking member is connected to the inner wall of the bottom unit.

In the toilet for pet dogs according to another aspect of the present invention, at the upper one side of the bottom unit, a bottom unit inlet is formed at a position corresponding to the inlet of the isolation container unit, and wherein the bottom unit inlet is surrounded by a pair of partitions disposed in a horizontal direction to protrude upward at facing inner walls of the bottom unit, a support portion installed between the pair of partitions at one side of the bottom unit, and a water collecting wall formed in a vertical direction at one side of the drain plate.

In this case, the bottom unit includes a funnel installed at the top of the bottom unit inlet, the funnel includes a opening portion corresponding to the bottom unit inlet and frames surrounding the opening portion, and the height of the upper surface of the frames decreases toward the opening portion, and wherein, in the frames, a first vertical frame is mounted on the upper end of the water collecting wall formed in a vertical direction at one side of the drain plate and a second vertical frame is in contact with the inner side of the support portion. And the water collecting wall includes a curved portion which is formed with the same curvature as the roller on which the net-type belt is wound to closely surround one side of the roller, wherein, at the outer side of the first vertical frame, a roller facing surface which is formed with the same curvature as the curved portion of the water collecting wall to closely surround one side of the roller from the upper end of the curved portion of the water collecting wall is formed and a sharp blade is formed on the upper end of the roller facing surface.

In the toilet for pet dogs according to another aspect of the present invention, wherein the toilet for pet dogs further comprises a connection detecting means that is installed in the bottom unit to detect whether the isolation container unit is assembled or disassembled.

In the toilet for pet dogs according to another aspect of the present invention, a plurality of wheels is mounted on the other side of the bottom unit and a support portion having the same height as the plurality of wheels protrudes at the top unit.

In the toilet for pet dogs according to another aspect of the present invention, wherein the toilet for pet dogs further comprises: an isolation container cover which is connected to the inlet of the isolation container unit when the isolation container unit is separated from the bottom unit, wherein the isolation container cover includes a cover portion having a size corresponding to the inlet, a connection member connecting the cover portion and the isolation container unit, an outlet protruding from one side of the cover portion, and a cap mounted on the outlet.

In the toilet for pet dogs according to another aspect of the present invention, wherein the conveyor unit includes; a driving roller and a driven roller on which the net-type belt is wound; a support frame including a vertical frame disposed at one side of the driving roller and a horizontal frame having an inner space and a bearing housing insertion hole communicating with the inner space; a bearing housing installed in the inner space and connected to a roller shaft of the driven roller; a shaft insertion hole which is a portion through which the roller shaft of the driven roller passes and formed downward from upper end of the inner wall of the horizontal frame and then extended in a horizontal direction; a fixing member fixed to the horizontal frame in the inner space; a tension control bar which is installed between the bearing housing and the fixing member and has an engaging member selectively protruding to the lower surface; an engaging groove which is a portion to which the engaging member of the tension control bar is inserted and formed on the bottom of the inner space; and an elastic means installed between one side of the tension control bar and the fixing member.

In this case, the tension control bar includes; a body having a penetrating portion and having a spring jaw formed at the inside of the penetrating portion; a first spring mounted on the spring jaw; an engaging member having a head having a larger diameter than that of the first spring and penetrating through the first spring; a second spring installed at the top of the head of the engaging member; a button installed at the top of the second spring; a guide groove which is formed on an outer circumference of the button and includes a button ascending groove, a button descending groove, a first seating surface formed concavely downward from a connection portion between the lower end of the button descending groove and the lower end of the button ascending groove, a second seating surface formed concavely downward from a connection portion between the upper end of the button descending groove and the upper end of the button ascending groove, a first guide protrusion protruding toward the first seating surface from the top of the first seating surface, and second guide protrusion which protrudes toward the second seating surface from the top of the second seating surface and is formed between a first upper guide surface connected to the inner wall of the button descending groove and a second upper guide surface connected to the inner wall of the button ascending groove; and a button support shaft of which one end is inserted to the guide groove by passing through one side of the body and which is alternately placed on the first seating surface and the second seating surface whenever the button is pressed. In this case, wherein the second spring has an elastic coefficient larger than that of the first spring.

### Advantageous Effects

According to the present invention, since an inner part of a toilet for a pet dog may be more rapidly dried through a fan installed outside a cleaning chamber cover, it is possible to effectively prevent generation of germs or generation of odor due to moisture.

Further, a lower part of a conveyor mounting plate of a bottom unit may be more clearly cleaned by using a separate nozzle.

In addition, a sterilizing lamp provided in an isolation container cover is continuously or periodically lighted on to prevent the generation of the germs and the generation of the odor in an isolation container unit.

Moreover, a drain plate and a periphery thereof are sterilized by installing the sterilizing lamp on a water collecting wall formed at one side of the drain plate to effectively prevent the generation of the germs and the generation of the odor due to the moisture.

Further, a load supporter supporting a net-type belt may be more clearly cleaned than the related art by using a separate cleaning means to prevent the generation of the germs and the generation of the odor.

In addition, a support frame and a funnel are installed on the periphery of an inlet of a bottom unit to more effectively and clearly process and collect excrement and cleaning water.

Moreover, a fitting protrusion is formed in an isolation container locking member provided in a top unit to enhance connection force of the top unit and the bottom unit. Further, a grip is connected to the isolation container locking member provided in the top unit and a wheel is mounted on the bottom unit to more conveniently transport the toilet for the pet dog.

In addition, a tension control bar is installed in a support frame of a conveyor unit to more conveniently perform disassembly and assembly of the conveyor unit and tension control of the net-type belt.

Further, an isolation container cover sealing an inlet of the isolation container unit is provided to more conveniently and safely drain the excrement.

In addition, a urine guide unit is installed at one side of the net-type belt by considering a habit of a male dog to pass urine with lifting one leg, while a urination plate is cleaned with water by installing a separate cleaning means to prevent the generation of the odor.

### DESCRIPTION OF DRAWINGS

FIG. 1 is an exploded perspective view of a toilet for pet dogs according to an exemplary embodiment of the present invention.

FIG. 2 is a perspective view of a toilet for pet dogs according to an exemplary embodiment of the present invention.

FIG. 3 is a perspective view in a different direction from FIG. 2.

FIG. 4 is a horizontal perspective view of a toilet for pet dogs according to an exemplary embodiment of the present invention.

FIG. 5 is a diagram illustrating a connection relation of a top unit and a urine guide unit.

FIG. 6 is a bottom diagram of the top unit.

FIG. 7 is a partial cross-sectional view illustrating a periphery of a cleaning roller.

FIG. 8 is a partial cross-sectional view illustrating a periphery of an inlet.

FIG. 9 is a diagram illustrating a side inlet of the top unit.

FIG. 10 is a diagram illustrating an isolation container locking member.

FIG. 11 is a diagram sequentially illustrating a using method of the isolation container locking member.

FIG. 12 is a diagram illustrating a connection relation of a side cover of the isolation container locking member.

FIG. 13 is a diagram illustrating a standing state of the toilet for pet dogs.

FIG. 14 is a perspective view of a bottom unit.

FIG. 15 is a perspective view illustrating a state in which a funnel is separated from the bottom unit.

FIG. 16 is a perspective view in a different direction from FIG. 15.

FIG. 17 is a diagram illustrating an appearance viewed from a left side of the bottom unit.

FIG. 18 is a cross-sectional view of a right vertical frame of the funnel.

FIG. 19 is a diagram illustrating an appearance in which an inner wall of an isolation container unit is connected to the bottom of the funnel.

FIG. 20 is a diagram illustrating an appearance in which a side wall of the isolation container unit is connected to the bottom of the funnel.

FIG. 21 is a diagram illustrating a connection relation of the bottom unit and a conveyer unit.

FIG. 22 is an exploded perspective view of a conveyor unit.

FIG. 23 is a diagram illustrating an appearance in which a load supporter is mounted on a support frame of the conveyor unit.

FIG. 24 is a diagram illustrating a nozzle provided in the load supporter.

FIG. 25 is a diagram illustrating an appearance in which water injected from the nozzle cleans the load supporter.

FIG. 26 is a diagram illustrating an appearance in which the nozzle of the load supporter injects the water between a driven roller and a net-type conveyor.

FIG. 27 is a perspective view illustrating a support frame and a roller.

FIG. 28 is a diagram illustrating an inner portion of a horizontal frame.

FIG. 29 is a partial perspective view illustrating a connection structure of the driven roller and the horizontal frame.

FIG. 30 is a partial perspective view illustrating a state in which the driven roller is pressed toward a driving roller.

FIG. 31 is a diagram sequentially illustrating a process of removing a bearing housing of the driven roller.

FIG. 32 is an exploded perspective view of a tension control bar according to an exemplary embodiment of the present invention.

FIG. 33 is a cross-sectional view illustrating an operation of the tension control bar according to the exemplary embodiment of the present invention.

FIG. 34 is a perspective view illustrating a button of the tension control bar according to the exemplary embodiment of the present invention.

FIGS. 35 and 36 are diagrams illustrating an operational principle of the button of the tension control bar according to the exemplary embodiment of the present invention, respectively.

FIG. 37 is an exploded perspective view of a tension control bar according to another exemplary embodiment of the present invention.

FIG. 38 is a diagram illustrating an operational principle of the button of the tension control bar according to another exemplary embodiment of the present invention.

FIG. 39 is a diagram illustrating a structure of a drain port and an inlet port.

FIG. 40 is a diagram illustrating an appearance in which an isolation container cover is mounted on the isolation container unit.

FIG. 41 is a perspective view illustrating the isolation container cover.

FIG. 42 is a cross-sectional view of the urine guide unit.

FIG. 43 is a cross-sectional view illustrating an appearance in which a water barrier wall is formed inside the urine guide unit.

### MODES OF THE INVENTION

Hereinafter, preferable exemplary embodiments of the present invention will be described with reference to the accompanying drawings.

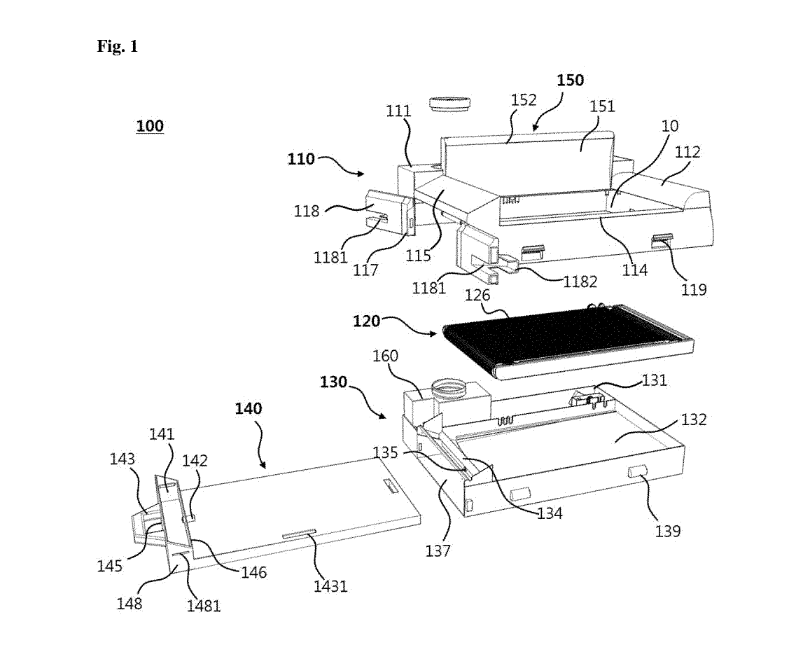

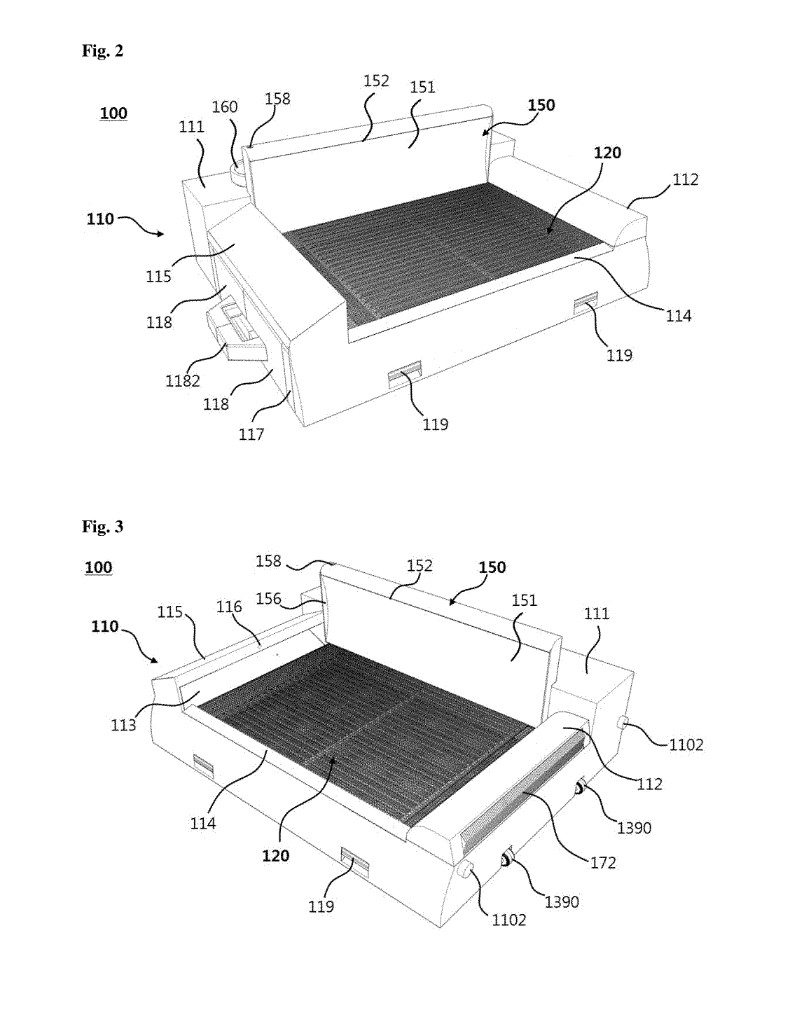

As illustrated in an exploded perspective view of FIG. 1, perspective views of FIGS. 2 and 3, and a cross-sectional view of FIG. 4, a toilet 100 for pet dogs according to an exemplary embodiment of the present invention comprises a top unit 110, a bottom unit 130, a conveyor unit 120 installed between the top unit 110 and the bottom unit 130 including a net-type belt 126 on which pet dogs are placed and excrete, an isolation container unit 140 for isolate and store excrement separably combined with the bottom unit 130, and a urine guide unit 150 connected to one side of the top unit 110, and the like.

Hereinafter, in the present specification, for convenience of description, a direction in which the net-type belt 126 moves will be defined as a horizontal direction and a direction orthogonal to the horizontal direction will be defined as a vertical direction.

The top unit 110 is a frame structure that surrounds the outer periphery of the bottom unit 130 while supporting the conveyor unit 120 and surrounds a substantially rectangular opening portion 10.

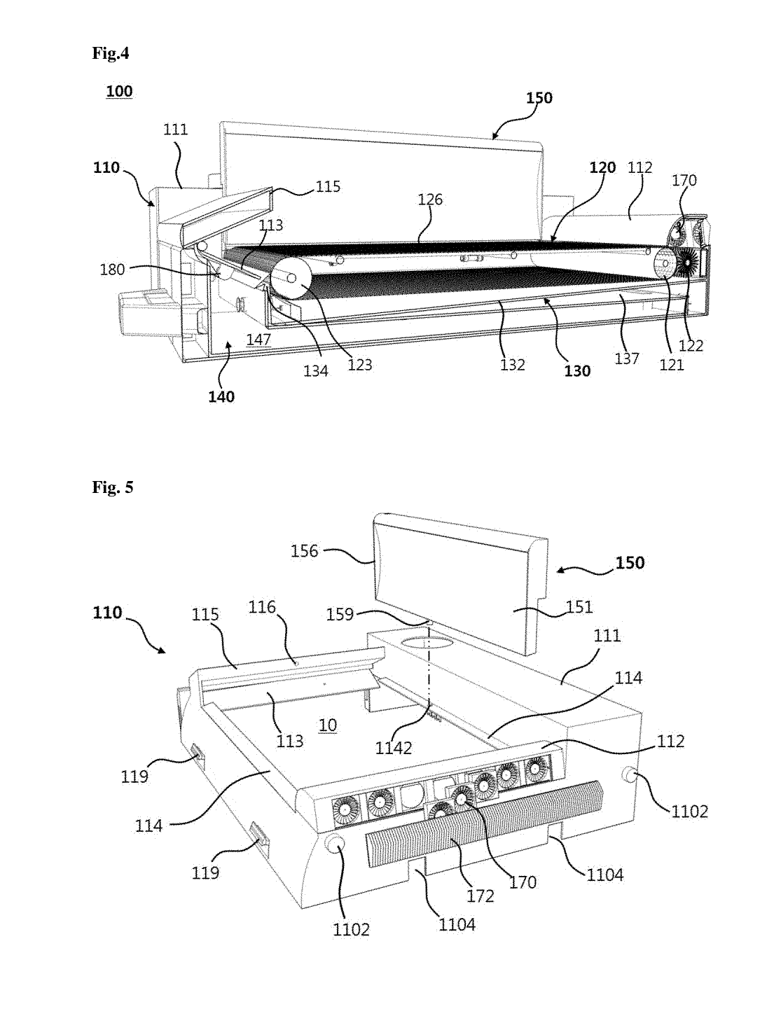

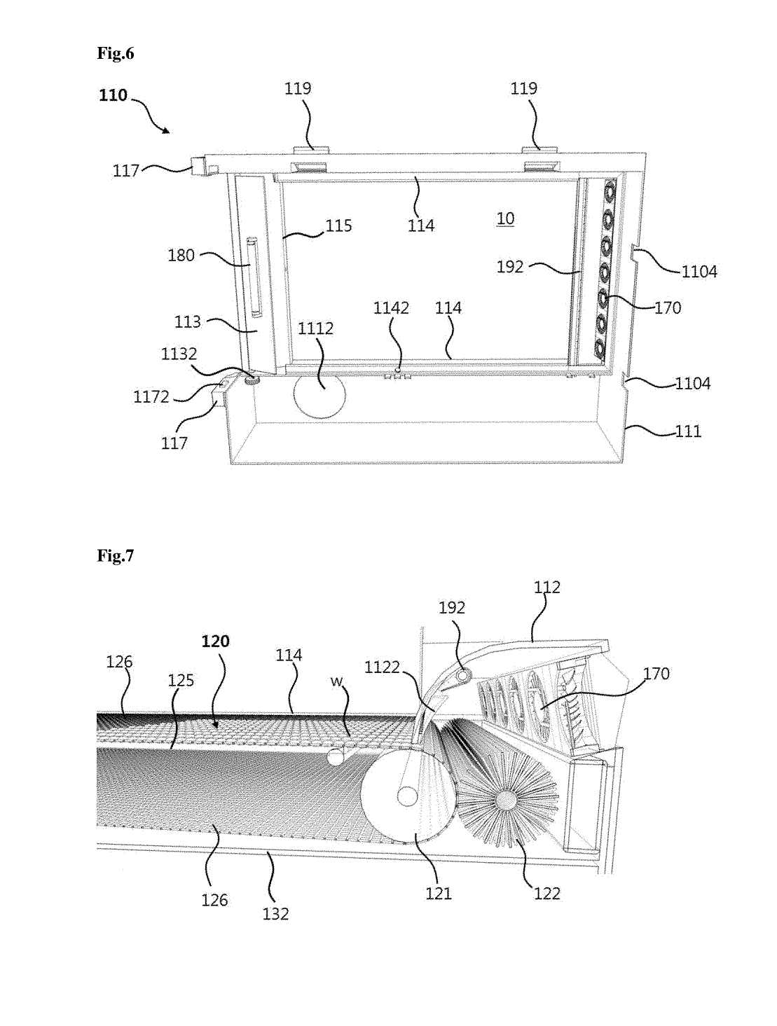

When described in more detail with reference to a perspective view of FIG. 5 and a bottom view of FIG. 6, the top unit 110 includes an engine chamber cover 111 at the rear side of the opening portion 10 vertically formed and includes a cleaning chamber cover 112 and an isolation container cover 113 at the right side and the left side, respectively.

The engine chamber cover 111 is a part that covers the top of an engine chamber 131 (FIG. 1) formed in the bottom unit 130 and may include a through-hole 1112 exposing an upper end of a water container 160 installed in the engine chamber 131.

The cleaning chamber cover 112 covers a space where cleaning for the net-type belt 126 is performed by a cleaning roller 122.

The cleaning chamber cover 112 has a shape in which a height is decreased toward the lower left end from the upper right end and the lower end is positioned to be close to the top of a shaft of the driving roller 121 of the conveyor unit 120. Since the net-type belt 126 is wound around the driving roller 121, the lower end of the cleaning chamber cover 112 may be installed to be spaced apart from the upper surface of the net-type belt 126 so as not to interfere with the net-type belt 126.

In the exemplary embodiment of the present invention, the cleaning chamber cover 112 is formed as a curved surface, but is not limited thereto, and thus, the cleaning chamber cover 112 may also be formed as a planar slant surface or formed to include both the slant surface and the curved surface.

A nozzle is installed at the ceiling of the cleaning chamber cover 112, and the nozzle 192 includes a water supply pipe disposed in the same direction as the cleaning roller 122 and a plurality of spray holes formed in the water supply pipe. A direction of the spray holes may be formed to face a portion where a brush of the cleaning roller 122 and the net-type belt 126 contact each other. Further, in the water supply pipe of the nozzle 192, the plurality of spray holes may be formed in a line in a vertical direction or be formed in two or more lines.

When the spray holes are formed in two or more lines, each line may be differently used. For example, the spray holes in a first line are used for cleaning the net-type belt 126 together with the cleaning roller 122 to face the portion where the brush of the cleaning roller 122 and the net-type belt 126 contact each other, and the spray holes in a second line may be used for cleaning the load supporter 125 supporting the net-type belt 126.

In the exemplary embodiment of the present invention, in order to clean the load supporter 125 by using the spray holes in the second line, a cleaning guide 1122 for guiding water sprayed from the spray holes in the second line to a predetermined position of the top of the driving roller 121 is formed at the bottom of the cleaning chamber cover 112.

As a result, the water flowing along the cleaning guide 1122 is agglomerated into the plurality of holes formed in the net-type belt 126, and as the net-type belt 126 moves in a horizontal direction, the agglomerated water may clean horizontal ribs 1254 (FIG. 23) of the load supporter 125 positioned therebelow.

When the pet dog urinates, the load supporter 125 may be sufficiently cleaned in this way. However, when soft feces flow down to contaminate the load supporter 125, it is difficult to expect sufficient cleaning only in this way, and thus, a separate cleaning mean may be installed in the load supporter 125 itself. This will be described below.

Meanwhile, the toilet 100 for pet dogs according to the exemplary embodiment of the present invention is characterized by providing a means of forcibly drying the inside in order to prevent propagation of germs after water cleaning.

In detail, as illustrated in FIGS. 5 to 7, one or more fans 170 are installed at the side of the cleaning chamber cover 112 and a fan protection cover 172 is installed at the outside of the fans 170. As such, when the fans 170 are installed at the side of the cleaning chamber cover 112, the fans 170 may rapidly dry an inner space of the toilet 100 for pet dogs which is moistful by the water cleaning, thereby preventing propagation of germs and generation of odor.

That is, air supplied from the fans 170 descends along the left inner surface of the cleaning chamber cover 112 and then has no choice but to move downwards by passing through the brush of the cleaning roller 122, thereby rapidly drying the cleaning roller 122. Further, a part of the air that passes through the cleaning roller 122 dries a drain plate 132 while moving along the surface of the drain plate 132 and the other part dries the net-type belt 126 while ascending by passing through the net-type belt 126.

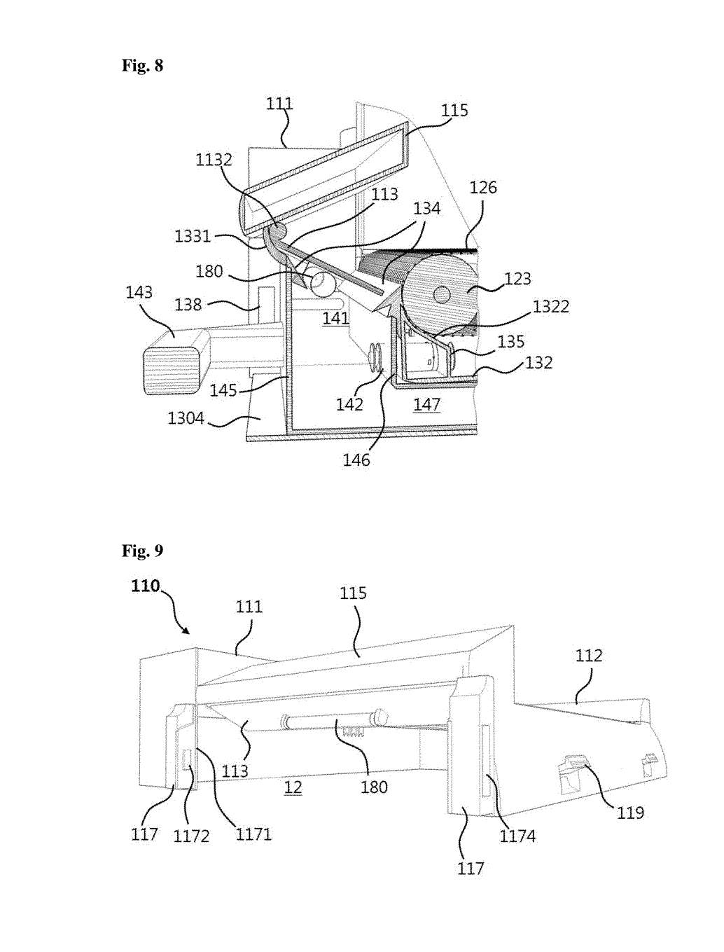

Meanwhile, the isolation container cover 113 provided in the top unit 110 serves to close and open an inlet 141 of the isolation container unit 140 as illustrated in a partial cross-sectional view of FIG. 8. The inlet 141 of the isolation container unit 140 is positioned at the bottom of an inlet 1308 (FIG. 15) of the bottom unit 130 as described below and thus, the isolation container cover 113 serves to open and close the inlet 1308 of the bottom unit.

A vertical cover rotation shaft 1132 is coupled with the left end of the isolation container cover 113 and one end of the cover rotation shaft 1132 is connected to a cover driving means (not illustrated) installed in the engine chamber 131 (FIG. 1) provided in the bottom unit 130.

Particularly, in the exemplary embodiment of the present invention, in order to prevent propagation of germs and generation of odor by sterilizing the excrement stored in the isolation container unit 140, a sterilizing lamp 180 is installed on the bottom of the isolation container cover 113. In addition, a control device (not illustrated) of the toilet 100 for pet dogs may interlock an operation of the sterilizing lamp 180 with a rotation driving means of the isolation container cover 113. That is, the control device may control the sterilizing lamp 180 to be turned off while the isolation container cover 113 is opened, and the sterilizing lamp 180 to be turned on while the isolation container cover 113 is closed.

Meanwhile, it is necessary to prevent the pet dog from touching or approaching the isolation container cover 113 with curiosity while the isolation container cover 113 automatically rotates after excretion. To this end, a protection cover 115 may be installed at the top of the isolation container cover 113. In this case, the cover rotation shaft 1132 may be rotatably coupled with one side of the bottom of the protection cover 115.

In the embodiment of the present invention, a detection sensor 116 that can detect whether the pet dog is on board is installed on one side of the protection cover 115 facing the net-type belt 126. A type of detection sensor 116 is not particularly limited, and for example, an optical sensor, an ultrasonic sensor, a capacitive proximity sensor, a proximity sensor using induction magnetic force, and the like may be used.

Further, the detection sensor 116 is not necessarily installed in the protection cover 115, but may be installed in another part of the top unit 110, the urine guide unit 150 or the like.

As illustrated in FIG. 9, the top unit 110 has an inlet 12 for entering the isolation container unit 140 at the bottom of the isolation container cover 113.

Isolation container locking members 117 that rotates based on a vertical shaft 1171 may be provided on one side and the other side of the inlet 12. Herein, the vertical shaft 1171 may be a separately installed shaft or a vertical connection portion that is formed to be flexibly thin as a portion connecting the isolation container locking member 117 and the side wall of the top unit 110.

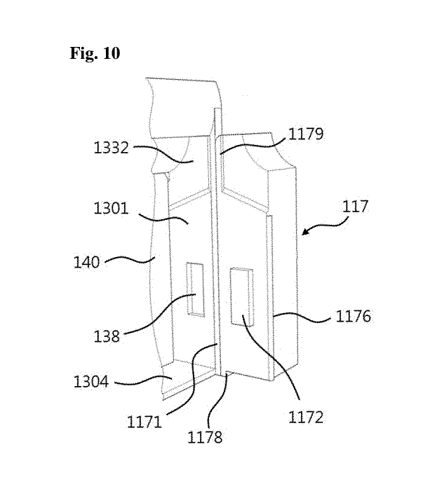

A connection protrusion 1172 is formed on an inner side adjacent to the vertical shaft 1171 in each isolation container locking member 117, and the connection protrusion 1172 is inserted to connection grooves 138 (FIGS. 8 and 10) formed on facing inner walls of a receiving space 137 of the bottom unit 130, respectively, and serves to lock the isolation container unit 140 so as not to be removed.

That is, when the connection protrusion 1172 is inserted to the connection groove 138 of the bottom unit 130 by rotating the isolation container locking member 117 while the isolation container unit 140 is inserted to the bottom unit 130, the isolation container locking member 117 presses the outer surface of the isolation container unit 140 to support the isolation container locking member 117 not to be removed.

Meanwhile, the connection means of the isolation container locking member 117 and the bottom unit 130 is not limited thereto, and thus, a connection groove is formed in the isolation container locking member 117 and the connection protrusion corresponding thereto may be formed on the inner surface of the bottom unit 130.

In the isolation container locking member 117, as illustrated in FIG. 10, a separation prevention projection 1176 may be formed at an outer edge of the inner side with the connection protrusion 1172.

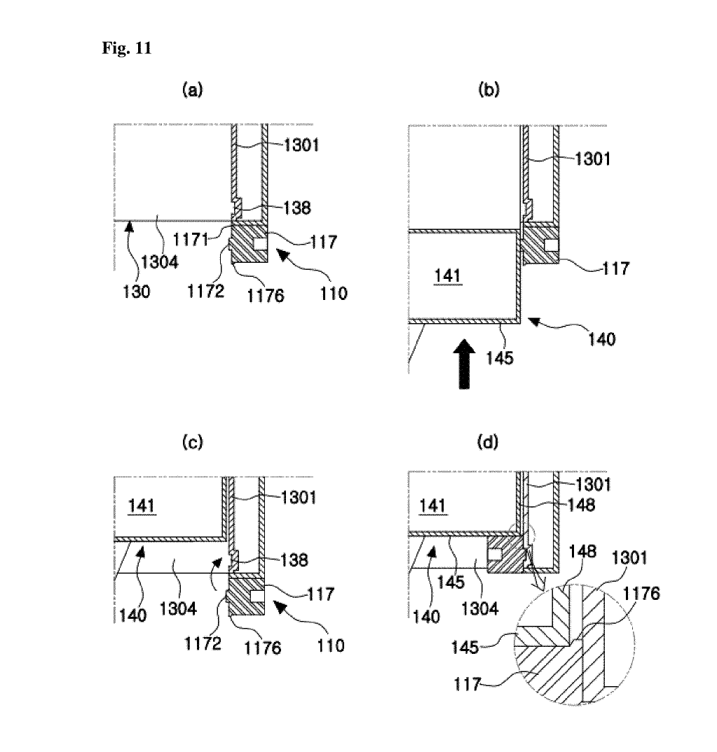

As illustrated in FIG. 11, when the connection protrusion 1172 of the isolation container locking member 117 is inserted to the connection groove 138 of the bottom unit 130 while the isolation container unit 140 is inserted to the bottom unit 130, the separation prevention projection 1176 is inserted to a gap between a side wall 148 of the isolation container unit 140 and a side wall 1301 of the bottom unit 130 to prevent the isolation container locking member 117 from being easily removed.

Further, in the isolation container locking member 117, a first stopper 1178 protrudes downwards from the lower end of the outer side adjacent to the vertical shaft 1171 and a second stopper 1179 may protrude from the isolation container locking member 117 to be adjacent to the vertical shaft 1171 at the top of the inner side with the connection protrusion 1172.

The first and second stoppers 1178 and 1179 serve to counter external force applied to the isolation container locking member 117 while the isolation container locking member 117 is connected to the connection groove 138 of the bottom unit 130.

In detail, when the connection protrusion 1172 of the isolation container locking member 117 is inserted to the connection groove 138 of the bottom unit 130, the first stopper 1178 serves to counteract the external force while the inner surface thereof contacts the outer end of the bottom 1304 of the bottom unit 130, and the second stopper 1179 serves to counteract the external force while the inner surface thereof contacts the outer end of a partition 1332 provided in the bottom unit 130.

When the first and second stoppers 1178 and 1179 are formed in the isolation container locking member 117, the first and second stoppers 1178 and 1179 may prevent excessive force from being applied to an outer wall 145 (FIG. 11) of the isolation container unit 140 even though the external force is applied to the isolation container locking member 117.

Meanwhile, each side cover 118 may be connected to an opposite side of the inner side with the connection protrusion 1172 in each isolation container locking member 117.

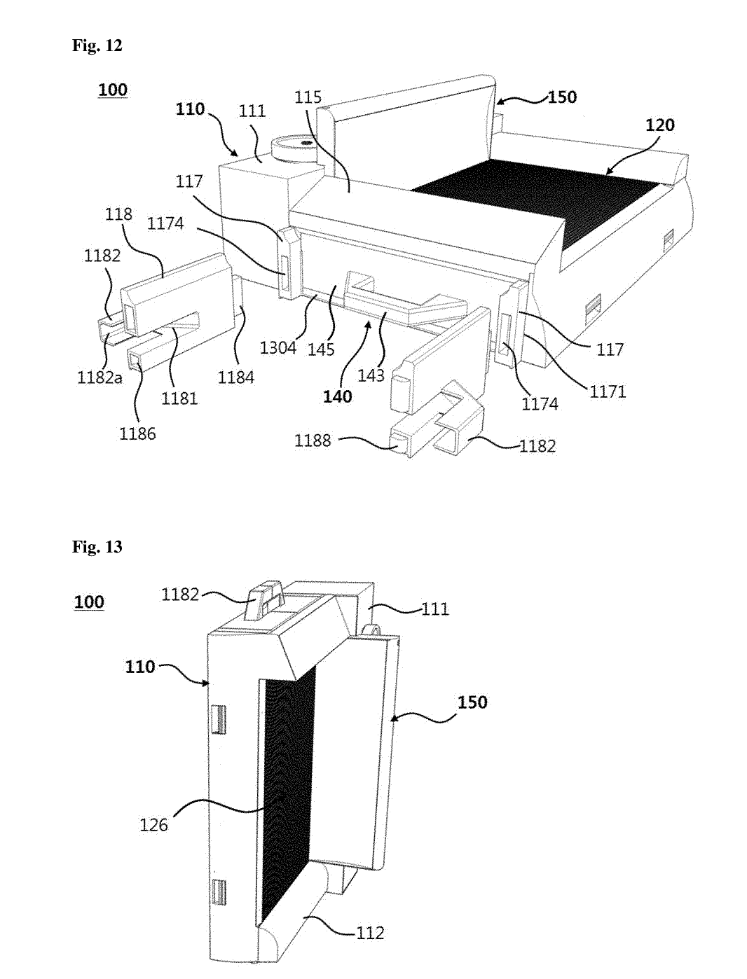

To this end, in each isolation container locking member 117, a side cover connection portion 1174 having a groove shape is formed and a locking member connection portion 1184 is formed at one end of each side cover 118 as illustrated in FIG. 12. In the drawing, the side cover connection portion 1174 has a groove shape and the locking member connection portion 1184 has a protrusion shape inserted to the groove, but of course, the shapes are opposed to each other.

Each side cover 118 may include a means serving as a grip when the toilet 100 for pet dogs is carried. In detail, each side cover 118 may include a cutout portion 1181 formed in a horizontal direction from the other end and a grip portion 1182 which protrudes from the outside of the side cover 118 to the outside of the cutout portion 1181 and formed with a receiving groove 1182a at the inner side.

Further, cover connection portions 1186 and 1188 capable of being connected to an opposite side cover 118 may be formed at the other end of each side cover 118 so that two side covers 118 may be connected to each other. The cover connection portions 1186 and 1188 may be a groove and a protrusion which correspond to each other.

Accordingly, while the isolation container unit 140 is inserted to the bottom unit 130, when each side cover 118 is connected to each isolation container locking member 117 and the respective side covers 118 rotate to face each other, the grip 143 of the isolation container unit 140 is inserted to the receiving groove 1182a of the grip portion 1182 by passing through the cutout portion 1181 of each side cover 118.

FIG. 2 illustrates an appearance in which the grip 143 of the isolation container unit 140 is inserted to the receiving groove 1182a of the grip portion 1182.

In this state, since a user holds the grip 143 of the isolation container unit in addition to the grip portion 1182, when the grip portion 1182 is held and lifted, the top unit 110 and the isolation container unit 140 are lifted together.

Meanwhile, as illustrated in FIG. 5, the top unit 110 includes a pair of edge covers 114 that protrudes toward each opening portion 10 from the horizontal inner sides facing each other with the opening portion 10 interposed therebetween. The edge cover 114 serves to prevent the foot of the pet dog from being caught or impurities from being injected and prevent cleaning water from flowing to the side by covering the edge of the net-type belt 126 of the conveyor unit 120 installed therebelow.

Particularly, in the edge cover 114 positioned at the rear side of the pair of edge covers 114, a lower end of the urine guide unit 150 may be placed, and in this case, an insertion hole 1142 through which a water supply pipe 159 of the urine guide unit 150 passes may be formed in the edge cover 114.

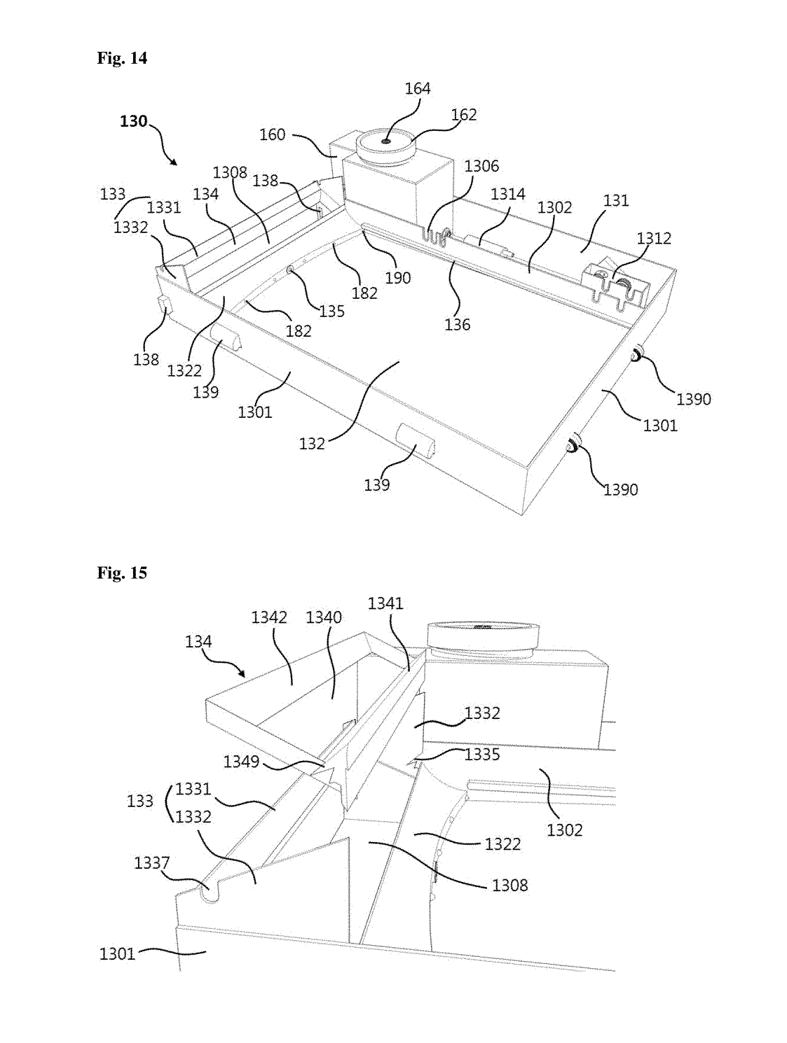

In addition, a hook 119 which is hooked on a hooking jaw 139 (FIG. 14) provided in the bottom unit 130 may be formed at the outside of the horizontal side of the top unit 110. Since the hook 119 and the hooking jaw 139 just exemplify a means the connects the top unit 110 and the bottom unit 130, the hook 119 and the hooking jaw 139 may be replaced with different types of connection means.

In the drawing, it is illustrated that the hook 119 is formed only at one side of the top unit 110, but of course, the hook 119 may be formed even at the opposite side.

Further, a wheel groove 1104 to which a wheel 1390 (FIG. 14) provided in the bottom unit 130 is inserted may be formed at the opposite side of the inlet 12 in the top unit 110.

Further, a support portion 1102 may be formed on the outer side of the opposite side to the inlet 12 in the upper unit 110. The support portion 1102 serves to support the toilet 100 for pet dogs so as not to be slid by the wheel 1390 when the toilet 100 for pet dogs stands and accordingly, may protrude at the same height as the wheel 1390.

Meanwhile, the bottom unit 130 includes a side wall 1301 surrounding the outer side and a lateral partition 1302 partitioning a space surrounded by the side wall 1301.

The rear space of the partition 130 is provided in the engine chamber 131 and a front space is provided in the receiving space 137 (in FIGS. 1 and 4) for inserting the isolation container unit 140 and the receiving space 137 communicates with the outside through the left inlet.

In the engine chamber 131, a water container 160 storing water, a pump 1314 supplying the water, a gear box 1312 connected to a driving roller 121 and a cleaning roller 122, a roller driving means (not illustrated) connected to the gear box 1312, and the like are installed. Further, although not illustrated, a control device controlling an overall operation of the toilet 100 for pet dogs, a hose connected to the pump 1314, and the like may be installed in the engine chamber 131.

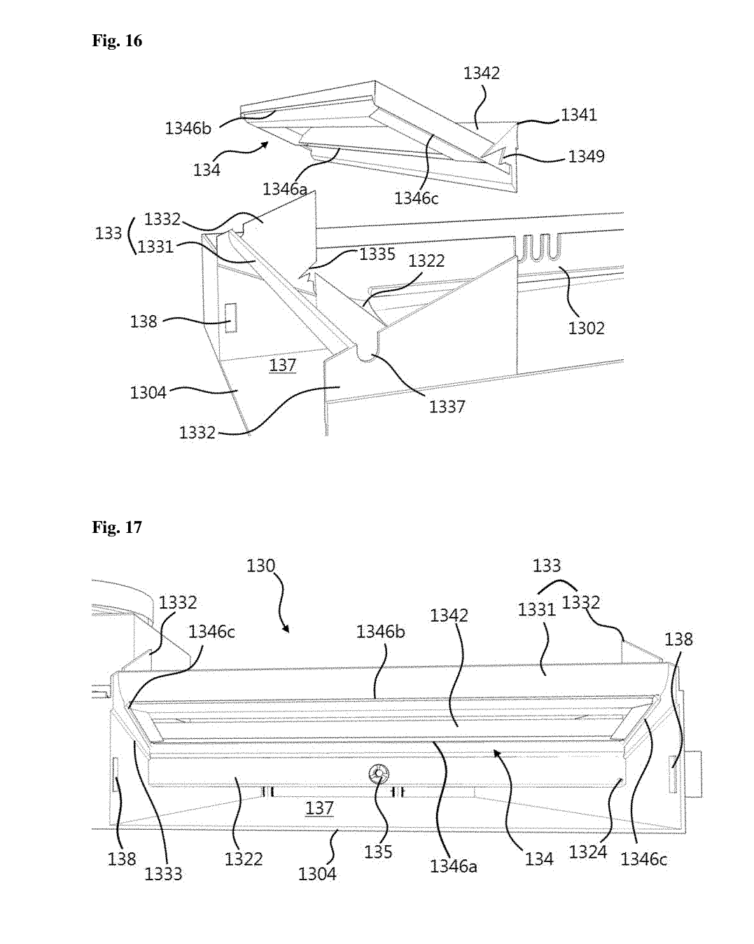

The receiving space 137 is formed between bottom 1304 (FIGS. 8 and 16) and the drain plate 132 and isolated from the outside except for the left inlet.

The drain plate 132 serves to guide urine excreted from the net-type belt 126 or cleaning water to flow into the isolation container unit 140 and to this end, has a slope in which a height is decreased toward the left side.

A water collecting wall 1322 collecting the urine or the water like a dam is formed in a vertical direction at the left side of the drain plate 132 and a drain port 135 is installed at the lower center of the water collecting wall 1322. The drain port 135 serves to discharge cleaning water and excrement to the inlet port 142 of the isolation container unit 140 and a detailed configuration will be described below with respect to the isolation container unit 140.

The water collecting wall 1322 may include a vertical portion at the lower end and a curved portion formed from the vertical portion to the upper end. The vertical portion of the water collecting wall 1322 serves to induce the urine or the water to the drain port 135. In order to more smoothly induce the urine or the water to the drain port 135, the vertical portion is formed in a curved surface which is convex to the left side rather than formed to coincide with a vertical direction, and the drain port 135 may be installed at the apex of the curved surface.

Meanwhile, in the embodiment of the present invention, the sterilizing lamp 182 that irradiates light toward the drain plate 132 is installed at the vertical portion of the water collecting wall 1322. The sterilizing lamp 182 sterilizes an upper space of the drain plate 132 to prevent propagation of germs and generation of odor and an optical axis may be installed to be parallel with the drain plate 132.

The curved portion of the water collecting wall 1322 may be formed to be very approximate to the net-type belt 126 wound on the driven roller 123 while having the same curvature as the driven roller 123 as illustrated in a cross-sectional view of FIG. 8. As such, when the water collecting wall 1322 is formed to a height in which the curved portion of the water collecting wall 1322 covers one side of the driven roller 123, even in an unavoidable situation in which the excrement cannot be injected into the isolation container unit 140, there is an advantage that a larger amount of excrement and water may be stored in the upper portion of the drain plate 132. Further, when a storage capacity increases, it may be a great help when an installation surface of the toilet 100 for pet dogs is inclined.

Meanwhile, when the driven roller 123 is positioned at the upper end of the water collecting wall 1322, an excretion surface (an upper surface of the conveyor unit 120) may be increased enough to be hardly climbed by the pet dog. Accordingly, like the embodiment of the present invention, when the curved portion is formed on the water collecting wall 1322 and the driven roller 123 is installed to surround one side of the driven roller 123 by the curved portion, there is an advantage that the storage capacity may be sufficiently obtained even while a height of the excretion surface is largely decreased as compared with when the driven roller 123 is positioned at the upper end of the water collecting wall 1322.

Conveyor mounting plates 136 protruding to the top of the drain plate 132 are formed at the partition 1302 and the front side wall 1301 which face each other with the drain plate 132 interposed therebetween, respectively. A horizontal support frame 124 of the conveyor unit 120 is placed on the conveyor mounting plate 136.

In order to prevent excrement and the like from being accumulated on the lower portion of the conveyor mounting plate 136, a nozzle 190 spraying water toward the lower space of the conveyor mounting plate 136 may be installed in the lower end of the water collecting wall 1322.

A mounting groove 1306 in which a hose connection hole 1245 provided in the support frame 124 of the conveyor unit 120 is mounted may be formed in the partition wall 1302.

Meanwhile, a bottom unit inlet 1308 which is vertically opened at the left side of the water collecting wall 1322 is formed in the bottom unit 130. The bottom unit inlet 1308 is a portion into which the excrement placed on the net-type belt 126 is injected and an inlet 141 of the isolation container unit 140 is positioned below the bottom unit inlet 1308.

The bottom unit inlet 1308 is surrounded by a support frame 133 and the water collecting wall 1322, and the support frame 133 includes a pair of partitions 1332 disposed in a horizontal direction at both sides of the bottom unit inlet 1308, respectively, and a support portion 1331 which is disposed in a vertical direction at one side of the bottom unit inlet 1308 and of which both ends are connected to the inner wall of each partition 1332.

In order to prevent the cleaning water or the excrement from being leaked or spattered out of the bottom unit 130, when the top unit 110 is connected to the top of the bottom unit 130, the partition 1332 enters the inside of the top unit 110 and then the upper end may be in close contact with the lower surface of the protection cover 115 of the top unit 110 and the upper end of the support portion 1331 may be in close contact with the lower surface of the protection cover 115.

In the embodiment of the present invention, the protection cover 115 of the top unit 110 has a slope increasing toward the right side, and accordingly, the upper end of the partition 1332 may have a slope increasing toward the right side corresponding thereto.

Further, a funnel connection groove 1335 may be formed at the right end of the partition 1332 as illustrated in FIGS. 15 and 16.

The support portion 1331 is disposed between ends of the partition 1332 and may have a slope decreasing toward the bottom unit inlet 1308 as illustrated in FIG. 8.

A cover rotation shaft 1132 is positioned between the support portion 1331 and the protection cover 115 and a shaft mounting groove 1337 on which the cover rotation shaft 1132 is mounted may be formed on the upper end of the partition 1332.

Meanwhile, the funnel 134 may be separately mounted on the top of the bottom unit inlet 1308 surrounded by the support frame 133 and the water collecting wall 1322 to more smoothly inject the excrement or the cleaning water conveyed along the net-type belt 126 into the isolation container unit 140.

As illustrated in FIGS. 15 to 17, the funnel 134 includes frames surrounding the opening portion 1340 corresponding to the bottom unit inlet 1308 and a guide surface 1342 inclined toward the bottom unit inlet 1308 is formed on the upper surface of the frames.

As illustrated in a cross-sectional view of FIG. 8, a right vertical frame of the funnel 134 is mounted on the upper end of the water collecting wall 1322 and a left vertical frame is in contact with the inner surface of the support portion 1331 of the support frame 133.

A partition connection portion 1349 protrudes at the outside of the two horizontal frames, and accordingly, when the funnel 134 is pressed with the funnel 134 inserted between the partitions 1332, the funnel 134 is mounted between the partitions 1332 while the partition connection portion 1349 is inserted to the funnel connection groove 1335 of the partition 133. Of course, detailed shapes or positions of the partition connection portion 1349 and the funnel connection groove 1335 are not limited to those illustrated in the drawing.

The lower surface of the funnel 134 may be in close contact with the upper end of the wall surrounding the inlet 141 of the isolation container unit 140. The reason is that the excrement or the cleaning water injected along the guide surface 1342 is not leaked to the outside.

Accordingly, as illustrated in FIG. 8, when an outer wall 145 formed at the left side of the inlet 141 of the isolation container unit 140 is higher than an inner wall 146 formed at the right side, the lower surface of the funnel 134 needs to be formed at a height corresponding thereto.

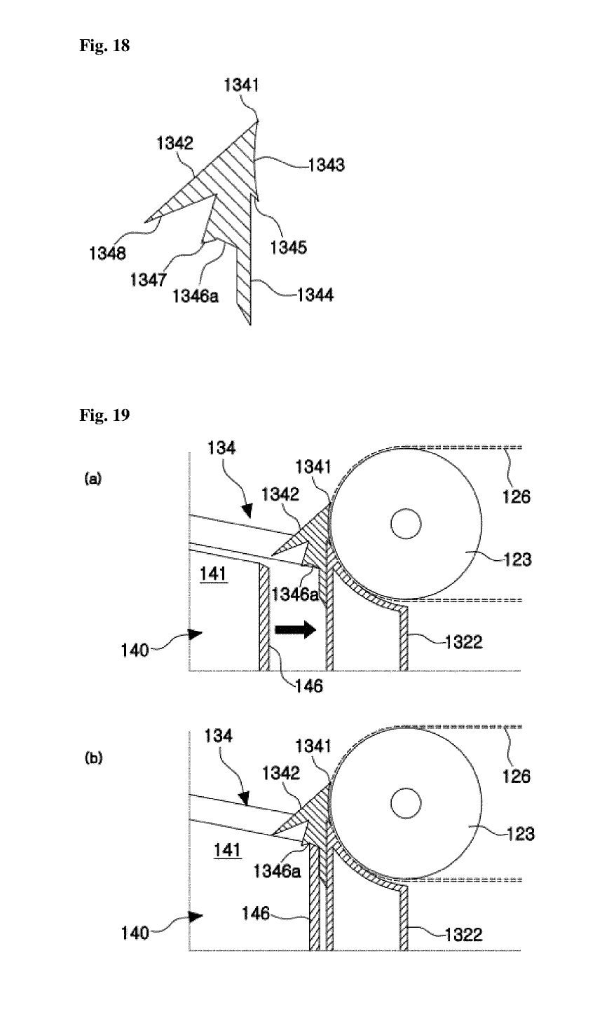

Meanwhile, as illustrated in a horizontal cross-sectional view of FIG. 18, the right vertical frames of the funnel 134 includes a water collecting wall contact surface 1344 contacting the left side of the water collecting wall 1322, a roller facing surface 1343 of which a lower end protrudes outward the water collecting wall contact surface 1344, a water collecting wall connection groove 1345 formed between the water collecting wall contact surface 1344 and the roller facing surface 1343, and a blade 1341 sharply formed at the upper end of the roller facing surface 1343.

The roller facing surface 1343 has the same curvature as the driven roller 123 and is close to the surface of the net-type belt 126 wound on the driven roller 123 at the top of the curved portion of the water collecting wall 1322.

Accordingly, the excrement moving along the net-type belt 126 is separated from the net-type belt 126 by the blade 1341 formed at the upper end of the roller facing surface 1343 to be injected to the inlet 141 of the isolation container unit 140 along the guide surface 1342.

Further, an upward inclined surface 1348 connected to the lower end of the guide surface 1342 is formed on the lower surface of the right vertical frame of the funnel 134. As such, since the lower end of the guide surface 1342 is sharpened when the upward inclined surface 1348 is formed, the cleaning water flowing along the guide surface 1342 may be easily injected into the inlet 141 of the isolation container unit 140 due to weak stress.

Further, an inner wall connection groove 1346a is formed on the lower surface of the right vertical frame of the funnel 134 and a projection 1347 is formed on the front end of the inner wall connection groove 1346a. The inner wall connection groove 1346a is a portion into which the upper end of the inner wall (146 in FIGS. 8 and 19) formed on the right side of the inlet 141 of the isolation container unit 140 is inserted, and the projection 1347 serves to lock the inserted inner wall 146 so as not to be easily removed.

However, since the isolation container unit 140 is detachably connected to the bottom unit 130, an interface between the projection 1347 and the inner wall connection groove 1346a needs to be inclined enough to remove the isolation container unit 140.

FIG. 19 illustrates sequentially an appearance in which the isolation container unit 140 is connected to the bottom unit 130, and illustrates an appearance in which when the isolation container unit 140 is inserted to the bottom unit 130, the inner wall 146 of the isolation container unit 140 enters the bottom of the funnel 134 and when the isolation container unit 140 continuously moves, the upper end of the inner wall 146 is inserted to the inner wall connection groove 1346a while pushing the projection 1347.

In FIG. 19, it is illustrated that the upper end of the inner wall 146 has a slope decreasing toward the outside. Accordingly, the upper end of the inner wall 146 may be more easily inserted into the inner wall connection groove 1346a beyond the projection 1347 by forming the projection 1347 at a height enough to contact the inclined surface of the inner wall 146.

Meanwhile, a connection groove for engaging with the isolation container unit 140 may be formed on the lower surface of the remaining frame of the funnel 134.

That is, as illustrated in FIGS. 16 and 17, an outer wall connection groove 1346b is formed in a vertical direction on the lower surface of the left vertical frame of the funnel 134, and side wall connection grooves 1346c are formed on the lower surfaces of two horizontal frames in a horizontal direction, respectively.

The upper end of the outer wall (145 in FIG. 8) positioned on the left side of the inlet 141 of the isolation container unit 140 is connected to the outer wall connection groove 1346b. Further, the upper ends of side walls (148 in FIG. 1) positioned on both sides of the inlet 141 of the isolation container unit 140 are connected to two side wall connection grooves 1346c.

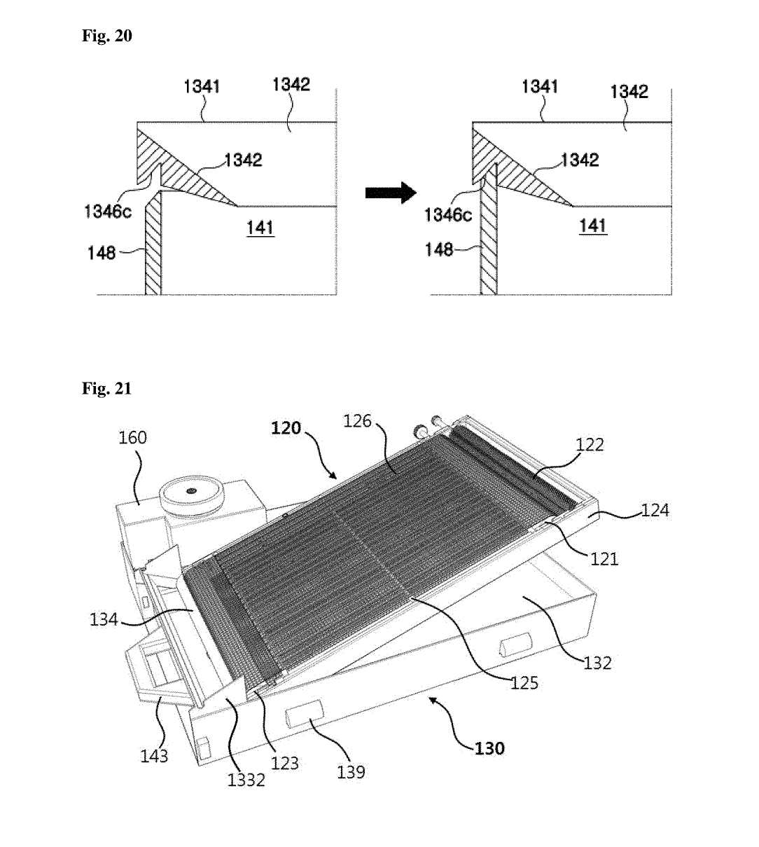

FIG. 20 is a partial cross-sectional view of the funnel 134 cut in the vertical direction and illustrates an appearance in which when the isolation container unit 140 is inserted into the bottom unit 130, the upper ends of the side walls 148 positioned on both sides of the inlet 141 are inserted and engaged with the side wall connection grooves 1346c.

FIG. 20 illustrates that the inclined surface is formed outwards at the upper end of the side wall 148 and the side wall connection groove 1346c has a shape corresponding thereto. In this way, an effect of reducing friction in the process of entering the isolation container unit 140 may be obtained.

In addition, as illustrated in FIG. 17, a connection detecting means 1324 detecting whether to attach and detach the isolation container unit 140 may be installed at the outer side wall of the water collecting wall 1322 of the bottom unit 130.

The connection detecting means 1324 may be a switch which is on/off according to a physical contact. That is, when the inner wall 146 of the isolation container unit 140 inserted to the bottom unit 130 presses the switch, the connection detecting means 1324 is turned on and when the pressed state is released while the isolation container unit 140 moves back, the connection detecting means 1324 is turned off.

Accordingly, when a control device (not illustrated) of the toilet 100 for pet dogs is connected to the connection detecting means 1324, the control device detects whether the isolation container unit 140 is mounted or not through the connection detecting means 1324 and may more effectively control an operation of the toilet 100 for pet dogs according to the detection result.

For example, the control device operates the driving roller 121, the cleaning roller 122, the pump 1324, and the like only when the isolation container unit 140 is mounted, and when the isolation container unit 140 is separated, the control device may control these operations to be stopped.

Further, the control device may control the sterilizing lamp 180 mounted on the bottom of the isolation container cover 113 to be turned on when the isolation container unit 140 is mounted and the sterilization lamp 180 to be turned off when the isolation container unit 140 is separated.

A type of connection detecting means 1324 is not particularly limited. Accordingly, the connection detecting means 1324 may be contact-type sensor or a non-contact type sensor that generates a predetermined electrical signal when the inner wall 146 of the isolation container unit 140 is touched or closer.

Further, since the connection detecting means 1324 needs not to detect only the inner wall 146 of the isolation container unit 140, the installation position may be different. For example, the connection detecting means 1324 may be installed on the inner wall or bottom of the receiving space 137 to detect the right end of the isolation container unit 140 in contact or non-contact manner.

As illustrated in FIG. 21, the conveyor unit 120 is mounted on the top of the drain plate 132 of the bottom unit 130 and specifically, the support frame 124 to be described below is placed on the conveyor mounting plate 136 formed on the partition 1302 and the side wall 1301 on both sides of the drain plate 132.

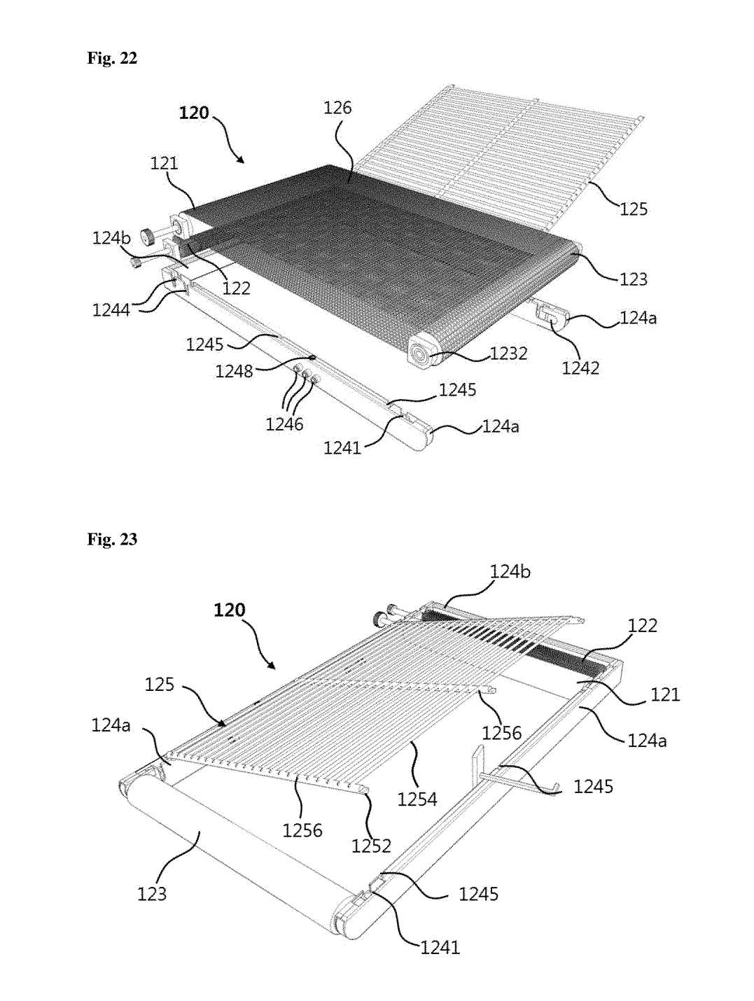

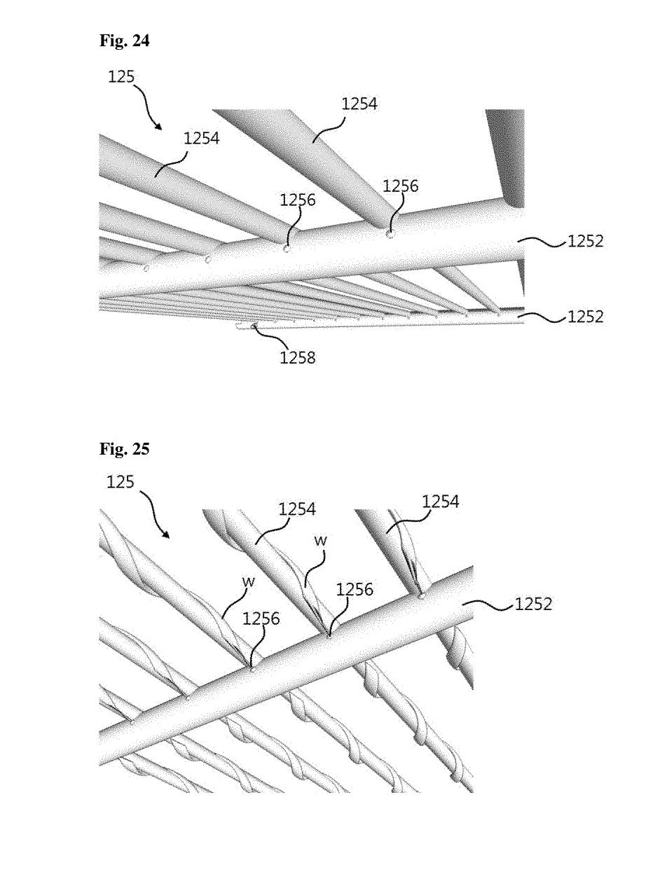

Referring to FIGS. 22 and 23, in more detail, the conveyor unit 120 includes a support frame 124, a driving roller 121 supported by the support frame 124, a cleaning roller 122 closely installed on one side of the driving roller 121, and a driven roller 123 spaced apart from the driving roller 121.

The net-type belt 126 having a plurality of through-holes is wound on the driving roller 121 and the driven roller 123 and the cleaning roller 122 cleans the surface of the net-type belt 126 with a brush from the outside of the driving roller 121 while rotating in the same direction as the driving roller 121.

The load supporter 125 is mounted on the upper end of the support frame 124 and the load supporter 125 includes a plurality of vertical ribs 1252 arranged in a vertical direction and a plurality of horizontal ribs 1254 arranged in a horizontal direction.

Particularly, the embodiment of the present invention is characterized in that a plurality of nozzles 1256 is formed on each vertical rib 1252 of the load supporter 125 to clean the load supporter 125 and the net-type belt 126 moving to the top thereof.

In detail, each vertical rib 1252 is a pipe structure of which both ends are closed, and a hose (not illustrated) supplying water supplied form the pump 1314 of the engine chamber 131 is connected to the vertical rib 1252.

In the embodiment of the present invention, a nozzle 1256 is formed for each portion where each vertical rib 1252 crosses the horizontal rib 1254. Each nozzle 1256 sprays the water in a direction (a left direction in the drawing) in which the net-type belt 126 of the top of the load supporter 125 moves and sprays the water slightly upwardly toward the bottom of the horizontal ribs 1254, not in the horizontal direction.

Particularly, when each nozzle 1256 is positioned immediately below the central axis of the horizontal ribs 1254 and water is sprayed obliquely toward the outer peripheral surface of the horizontal ribs 1254, as illustrated in FIG. 25, due to surface tension and adhesion of the water, there is an advantage that the periphery of the horizontal ribs 1254 may be cleaned more cleanly since sprayed water w rotates and flows along the surface of the horizontal ribs 1254.

In this case, if an angle between the spraying direction of each nozzle 1256 and the direction of the horizontal ribs 1254 is large, the water w flows on the surface of the horizontal ribs 1254 while rotating at dense intervals, and if the angle is small, the water w flows on the surface of the horizontal ribs 1254 while rotating at large intervals.

Of course, since the rotation flow is impossible when each nozzle 1256 sprays the water with excessive pressure, the spraying pressure of the pump needs to be appropriately adjusted. Further, the position, the spraying direction, and the like of the nozzle 1256 may be variously modified in a detailed application.

Meanwhile, since the vertical rib 1252 positioned at the leftmost side of the load supporter 125 is close to the driven roller 123, the water may be sprayed between the driven roller 123 and the net-type belt 126 using the nozzle 1256 formed herein.

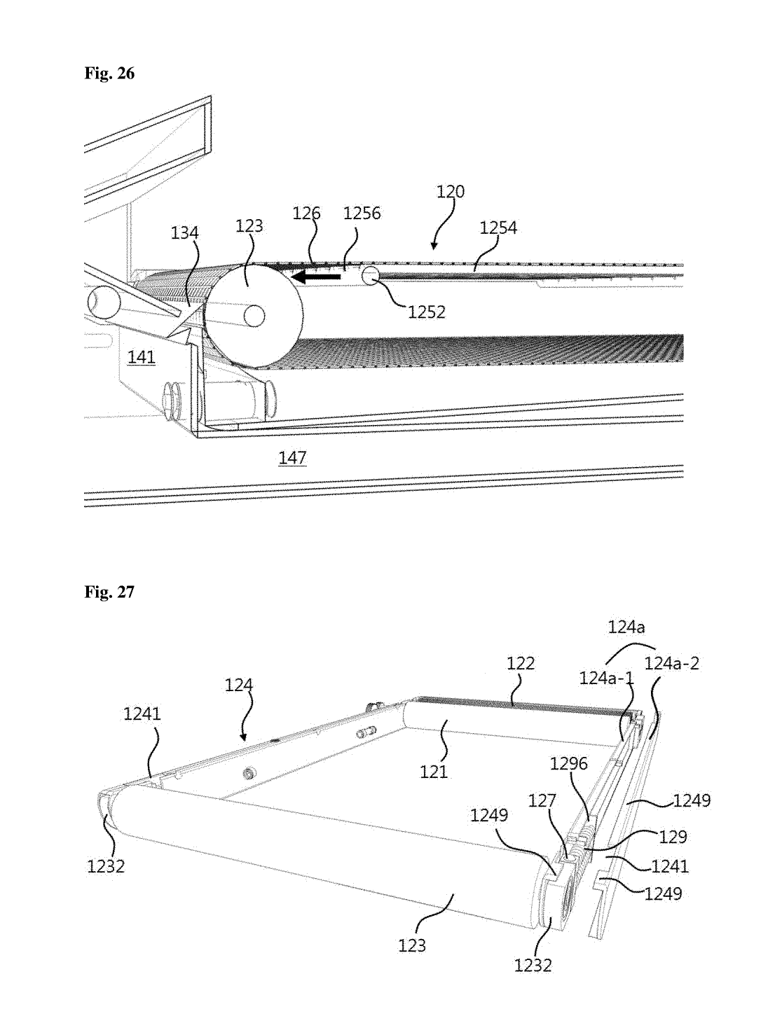

That is, as illustrated in FIG. 26, when the nozzle 1256 provided in the outermost vertical rib 1252 sprays the water between the driven roller 123 and the net-type belt 126, the excrement placed on the net-type belt 126 may be easily dropped and the driven roller 123 and the curved portion of the water collecting wall 1322 may be cleaned. Further, the sprayed water cleans the excretion surface through the hole of the net-type belt 126 and some of the water flows down to the inlet 141 along the funnel 134 to clean the funnel 134. Therefore, even when the isolation container cover 113 is then closed, even if the isolation container cover 113 is in contact with the funnel 134, the excrement is not stained in the isolation container cover 113.

As such, since a use and an operating time of the nozzle 1256 provided in the outermost vertical rib 1252 is different from those of the nozzles provided in other vertical ribs 1252, the nozzle 1256 may be connected to a separate pump or control water supply by using a separate control valve.

Meanwhile, in the embodiment of the present invention, the vertical rib 1252 itself is used as a water supply passage, but a separate water supply pipe is installed in a vertical direction instead of the vertical rib 1252, and a nozzle for spraying water in the above-described manner may be formed toward the horizontal rib 1254 in the water supply pipe. Further, a separate water supply pipe having a nozzle for spraying water between the driven roller 123 and the net-type belt 126 may be installed.

In addition, in the support frame 124 of the conveyor unit 120, a support mount groove 1245 into which a plurality of vertical ribs 1252 of the load supporter 125 are respectively inserted may be formed. Further, a shaft insertion hole 1244 through which the roller shaft of the driving roller 121 and the cleaning roller 122 passes may be formed.

Further, a plurality of hose connection ports 1246 connected to the pump 1314 of the engine chamber 131 by a hose may be installed at one side of the support frame 124. At least one of the hose connection ports 1246 may be used to supply water to the vertical rib 1252 through a connection port connected to the inside of the support frame 124. Further, at least one of the hose connection ports 1246 may be used to supply water to the water supply pipe 159 of the urine guide unit 150 through a urine guide unit connection port 1248 provided at the upper end of the support frame 124.

Meanwhile, as illustrated in FIGS. 22 and 23, the support frame 124 of the conveyor unit 120 includes a pair of horizontal frames 124a and one vertical frame 124b connecting one end of each horizontal frame 124a. The driving roller 121 and the cleaning roller 122 are arranged in the same direction as the vertical frame 124b inside the vertical frame 124b and the cleaning roller 122 is disposed between the driving roller 121 and the vertical frame 124b.

Bearing housings that rotatably support each roller shaft is connected to both ends of the driving roller 121 and the cleaning roller 122, and each bearing housing is connected to the horizontal frame 124a so as not to move. Further, a plurality of shaft insertion holes 1244 through which the roller shafts of the driving roller 121 and the cleaning roller 122 pass may be formed in a vertical direction from the upper end in the horizontal frame 124a.

The driven roller 123 is installed between the other ends of a pair of horizontal frames 124a and the bearing housings 1232 that rotatably support the roller shafts are movably connected to the horizontal frame 124a at both ends of the driven roller 123.

As such, when the bearing housing 1232 of the driven roller 123 is movably connected to the horizontal frame 124a, the bearing housing 1232 moves the driven roller 123 to adjust tension of the net-type belt 126 and easily disassemble and assemble the conveyor unit 120.

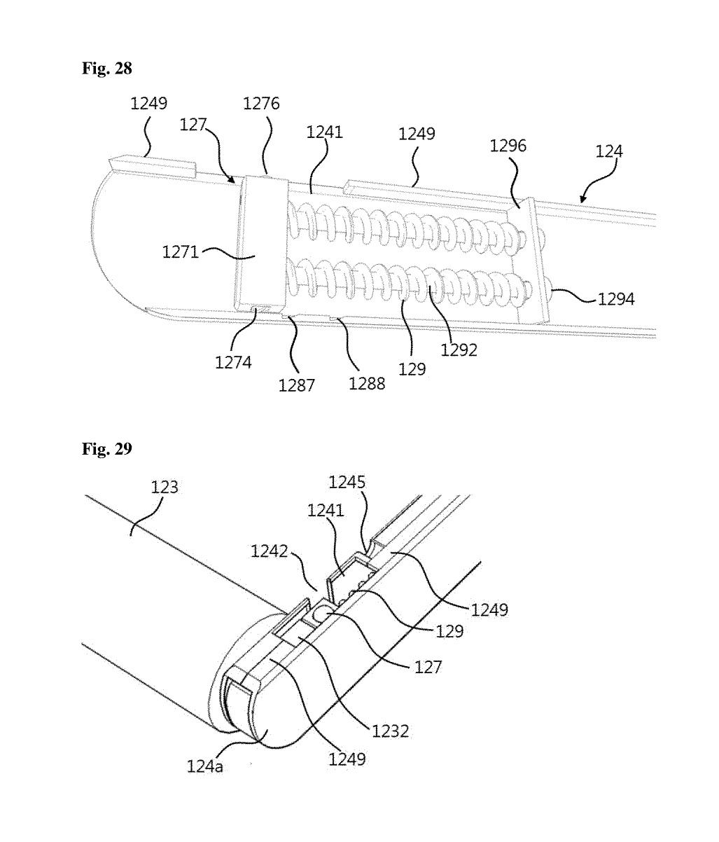

In more detail, as illustrated in FIGS. 27 and 28, the horizontal frame 124a includes a first frame 124a-1 at the inner side and a second frame 124a-2 at the outer side, and an inner space is formed between the first frame 124a-1 and the second frame 124a-2.

In the inner space of the horizontal frame 124a, a bearing housing 1232, a tension control bar 127, a spring 129, and a fixing member 1296 are sequentially installed from the other end of the horizontal frame 124a. Herein, the fixing member 1296 is fixed to the horizontal frame 124a.

In the upper surface portion 1249 of the horizontal frame 124a, a bearing housing insertion hole 1241 communicating with the inner space is formed, and in the inner side of the horizontal frame 124a, as illustrated in FIG. 22, a long-hole type shaft insertion hole 1242 which is formed vertically from the upper end and then extended toward the other end of the horizontal frame 124a is formed.

Referring to FIG. 28, the spring 129 is wound around each of a pair of spring shafts 1292 and one end of each spring shaft 1292 is connected to one side of the tension control bar 127 and the other end thereof is positioned at the right side of the fixing member 1296 by passing through the fixing member 1296. Further, a head 1294 having a larger diameter than that of the through-hole of the fixing member 1296 is formed at the other end of each spring shaft 1292.

Accordingly, when the tension control bar 127 moves toward the fixing member 1296, the spring 129 is compressed between the tension control bar 127 and the fixing member 1296 to generate restoring force.

The tension control bar 127 alternately repeats an operation of projecting or returning a engaging member 1274 to the lower end whenever a button 1276 provided at the upper end is pressed. On the bottom of the inner space of the horizontal frame 124a, a first engaging groove 1287 and a second engaging groove 1288 are formed to be spaced apart from each other at a predetermined interval along the a length direction of the horizontal frame 124a to which the engaging member 1274 of the tension control bar 127 is inserted.

The first engaging groove 1287 and the second engaging groove 1288 may be used for different purposes, respectively. For example, a user may attach and detach the load supporter 125 of the conveyor unit 120 while the engaging member 1274 of the tension control bar 127 is engaged with the first engaging groove 1287, and the user may attach and detach the driven roller 123 and the net-shaped belt 126 while the engaging member 1274 is engaged with the second engaging groove 1288.

In the embodiment of the present invention, two engaging grooves 1287 and 1288 are formed, but if necessary, a large number of engaging grooves may also be formed.

Meanwhile, when the conveyor unit 120 needs to be disassembled, the engaging member 1274 of the tension control bar 127 is hooked and fixed to the second engaging groove 1288 and the bearing housing 1232 of the driven roller needs to be removed through the bearing housing insertion hole 1241.

FIG. 29 is a diagram illustrating a state in which the driven roller 123 is farthest from the driving roller 121 while the engaging member 1274 of the tension control bar 127 is not engaged with the engaging grooves 1287 and 1288.

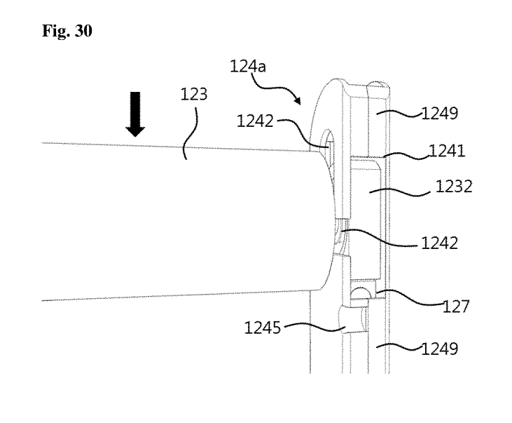

In this state, when the driven roller 123 is pressed toward the driving roller 121, as illustrated in FIG. 30, the bearing housing 1232 and the tension control bar 127 move while the roller shaft of the driven roller 123 moves along the long-hole type shaft insertion hole 1242. In this case, of course, since restoring force of the spring 129 is applied, the user needs to press the tension control bar 127 with larger force than the restoring force of the spring 129.

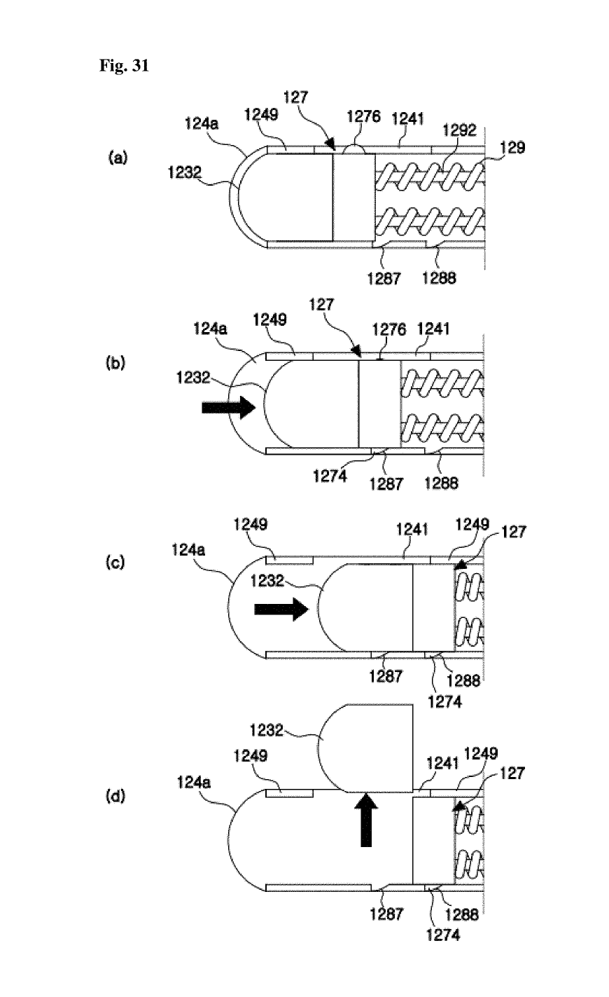

FIG. 31 illustrates sequentially a process of removing the bearing housing 1232 of the driven roller 123 from the horizontal frame 124a, and FIG. 31A illustrates a state in which the bearing housing 1232 of the driven roller 123 is not positioned directly below the bearing housing insertion hole 1241, but is biased to the left side, and thus the bearing housing 1232 is not removed by the upper portion 1249 of the horizontal frame 124a.

In this case, when the driven roller 123 is pressed toward the driving roller 121, as illustrated in FIG. 31B, the bearing housing 1232 and the tension control bar 127 move toward the driving roller 121. In order to stop the tension control bar 127 at a position of the first engaging groove 1287, as illustrated in the drawing, the engaging member 1274 protrudes by pressing the button 1276 to be inserted and engaged with the first engaging groove 1287.

As such, while the tension control bar 127 is engaged with the first engaging groove 1287, as described above, the load supporter 125 may be removed to the outside of the horizontal frame 124a while the net-type belt 126 of the conveyor belt 120 is slightly lifted.

The lower surface of the engaging member 1274 has an inclined surface so that a protruding height is decreased toward the driving roller 121 and the first engaging groove 1287 has an inclined surface corresponding to the lower surface of the engaging member 1274.

Accordingly, when the driven roller 123 is further pressed toward the driving roller 121 in a state where the engaging member 1274 is engaged with the first engaging groove 1287, the engaging member 1274 is inserted into the inside of the tension control bar 127 while being lifted along the inclined surface of the first engaging groove 1287. Subsequently, the bearing housing 1232 and the tension control bar 127 continuously move toward the driving roller 121 while the engaging member 1274 is disengaged from the first engaging groove 1287.

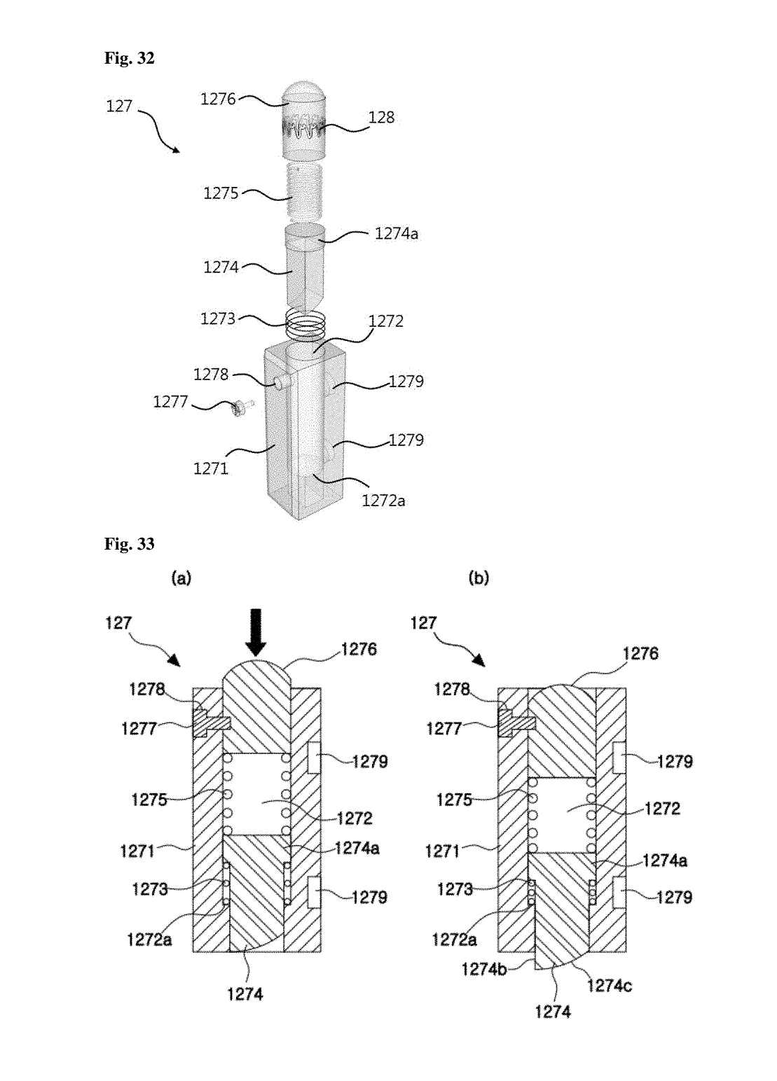

In this case, since the engaging member 1274 is in a state of receiving force downward by the second spring (1275 in FIG. 32) provided in the tension control bar 127 as described below, as illustrated in FIG. 31C, when the engaging member 1274 reaches the second engaging groove 1288, the engaging member 1274 protrudes downward again and engaged with the second engaging groove 1288.

While the engaging member 1274 of the tension control bar 127 is engaged with the second engaging groove 1288, the bearing housing 1232 is positioned directly below the bearing housing insertion hole 1241 and accordingly, as illustrated in FIG. 31D, the bearing housing 1232 may be removed to the top of the horizontal frame 124a through the bearing housing insertion hole 1241.

Meanwhile, as illustrated in FIGS. 31B and 31D, while the engaging member 1274 is inserted to the engaging grooves 1287 and 1288, the protruded engaging member 1274 may not be lifted even if the button 1276 is pressed.

When the tension control bar 127 moves to the driving roller 121, the spring 129 is compressed and the tension control bar 127 continuously receives force by the spring 129 in a left direction in the drawing, and as a result, the vertical surface (1274b in FIG. 33) of the engaging member 1274 strongly pushes the inner wall of the engaging grooves 1287 and 1288 not to move.

Accordingly, when the driven roller 123 intends to move in a direction farther from the driving roller 121 while the engaging member 1274 of the tension control bar 127 is engaged with the engaging grooves 1287 and 1288, first, the pressure applied downward to the engaging member 1274 is released by pressing the button 1276 and next, the engaging member 1274 needs to be removed from the engaging grooves 1287 and 1288 by slightly pushing the driven roller 123 to the driving roller 121.

Thereafter, when the force applied to the driven roller 123 is removed or reduced, the driven roller 123 moves in a direction farther from the driving roller 121 by the restoring force of the spring 129.

Hereinafter, the tension control bar 127 will be described in detail.

First, as illustrated in an exploded perspective view of FIG. 32, the tension control bar 127 according to the first embodiment of the present invention includes a body 1271 having a penetrating portion 1272 formed in a vertical direction, and a first spring 1273, an engagement member 1274, a second spring 1275, and a button 1276, which are sequentially inserted to the inside of the penetrating portion 1272.

A horizontal insertion hole 1278 communicating with the penetrating portion 1272 is formed at one side of the body 1271 and a button support shaft 1277 is inserted and connected to the insertion hole 1278.

Further, a pair of insertion holes 1279 to which one end of the spring support shaft 1292 described above is inserted and connected is formed at the other side of the body 1271.

Further, a spring jaw 1272a supporting to prevent the first spring 1273 from being removed downward is formed inside the penetrating portion 1272 of the body 1271.

The first spring 1273 may be a coil spring and the engaging member 1274 is installed by passing through the first spring 1273.

A head 1274a having a larger diameter than that of the first spring 1273 is formed at the upper end of the engaging member 1274. Accordingly, the first spring 1273 is positioned between the spring jaw 1272a of the penetrating portion 1272 and the head 1274a of the engaging member 1274 and serves to provide restoring force to the engaging member 1274 upward.

As illustrated in a cross-sectional view of FIG. 33, at the lower end of the engaging member 1274, one side facing the bearing housing 1232 is formed as a vertical surface 1274b and a lower surface 1274c may have a slope of which a height is decreased toward the opposite side.

It is preferred that the first and second engaging grooves 1287 and 1288 have a shape in which one side is formed as a vertical surface corresponding to the shape of the engaging member 1274 and the depth is deceased as further from the vertical surface.

The second spring 1275 is placed on the top of the head 1274a of the engaging member 1274 and is preferably a coil spring, but is not necessarily limited thereto. However, the second spring 1275 preferably has a larger elastic coefficient than that of the first spring 1273. The reason is that when the button 1276 is pressed, the engaging member 1274 may easily descend.

A guide groove 128 having a predetermined shape is formed on the circumference of the button 1276, and an end of the button support shaft 1277 connected to one side of the body 1271 is inserted into the guide groove 128, and as a result, the button 1276 are engaged with the button supporting shaft 1277 so as not to be removed upward.

FIG. 33A is a cross-sectional view illustrating a state in which the button 1276 of the tension control bar 127 ascends and FIG. 33B is a cross-sectional view illustrating a state in which the button 1276 of the tension control bar 127 descends.

In the drawing, it is illustrated that only one button supporting shaft 1277 is installed on the tension control bar 127, but it is not limited thereto. Accordingly, a plurality of button support shafts 1277 may be installed at an angle to balance the forces to prevent eccentricity.

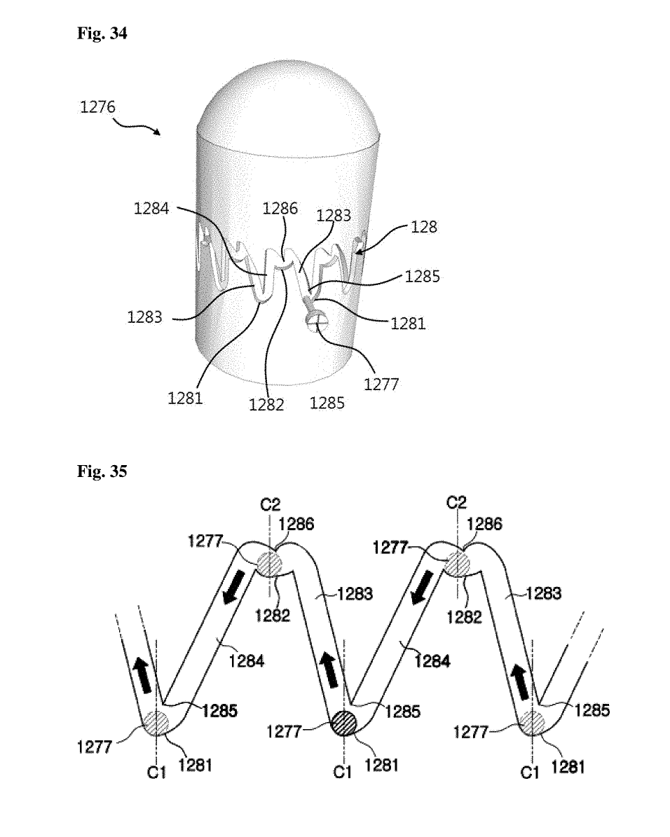

The tension control bar 127 according to the first embodiment of the present invention alternately repeats ascending and descending of the button 1276 whenever a user presses the button 1276 and to this end, a guide groove 128 having a specific shape is formed on the circumference of the button 1276 as illustrated in FIG. 34.

Hereinafter, a shape of the guide groove 128 and principle of ascending and descending of the button 1276 will be described in detail with reference to FIGS. 34 and 35.

First, the guide groove 128 includes a plurality of button descending grooves 1283 and a plurality of button ascending grooves 1284 which are formed alternately on the side of the button 1276. The lower end of the button descending groove 1283 is connected to the lower end of the button ascending groove 1284 adjacent to one side and the upper end of the button descending groove 1283 is connected to the upper end of another button ascending groove 1284 adjacent to the other side, and this connection is made continuously along the circumference of the button 1276.

Further, a first seating surface 1281 on which the button support shaft 1277 is placed when the button 1276 ascends is concavely formed at a portion where the lower end of the button descending groove 1283 is connected to the lower end of the button ascending groove 1284, and a sharp first guide protrusion 1285 protrudes toward the first seating surface 1281 at the top of the first seating surface 1281.

Particularly, as illustrated in FIG. 35, a contact center line C1 of the first seating surface 1281 and an apex of the first guide protrusion 1285 are not positioned on the same line based on the ascending direction of the button 1276, and the contact center line C1 of the first seating surface 1281 is separated from the apex of the first guide protrusion 1285 at one side (at a left side in the drawing).

Herein, the contact center line C1 of the first seating surface 1281 means a line that passes the center of the button support shaft 1277 in direction of ascending and descending of the button 1276 when the button support shaft 1277 is placed on the first seating surface 1281.

Since the button support shaft 1277 is fixed to the body 1271, when the button 1276 is pressed at the top while the button support shaft 1277 is placed on the first seating surface 1281, as the first guide protrusion 1285 descends, the button support shaft 1277 placed on the first seating surface 1281 enters the button descending groove 1283.

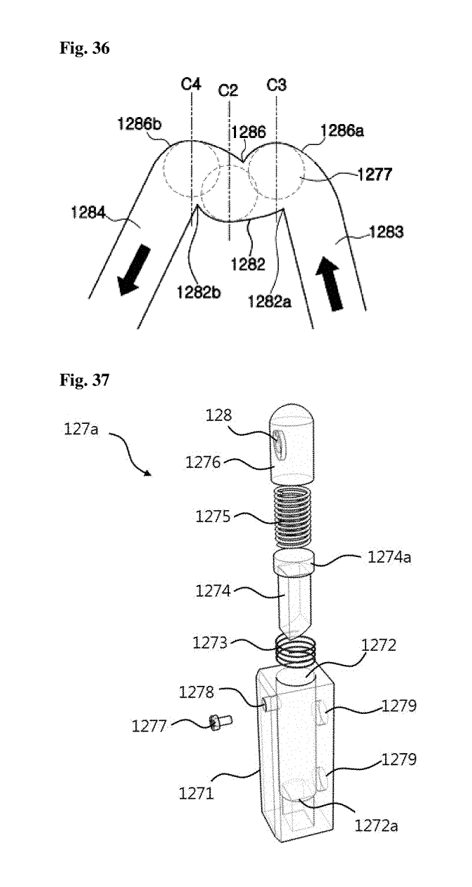

An arrow illustrated in FIGS. 35 and 36 illustrates a moving direction of the button support shaft 1277 whenever the button 1276 is pressed.

The button descending groove 1283 is formed obliquely to the vertical line, and accordingly, after the button support shaft 1277 enters the button descending groove 1283, while the button 1276 descends, an inclined inner surface of the button descending groove 1283 continuously contacts the button support shaft 1277 and as a result, the button 1276 rotates based on the central axis.

When the button 1276 continuously descends, the button support shaft 1277 continuously ascends with respect to the button descending groove 1283, and as a result, the button support shaft 1277 is placed on the upper second seating groove 1282 and the descending state of the button 127 is maintained.

Meanwhile, at a portion where the lower end of the button descending groove 1283 is connected to the lower end of the button ascending groove 1284, as illustrated in FIG. 36, when the button 1276 ascends, a second seating surface 1282 on which the button support shaft 1277 is placed is concavely formed, and a sharp second guide protrusion 1286 protrudes toward the second seating surface 1282 at the top of the second seating surface 1282.

Particularly, at both sides of the second seating surface 1282, a third guide protrusion 1282a and a fourth guide protrusion 1282b have an upwardly sharp shape, respectively. Accordingly, a boundary between the upper end of the button descending groove 1283 and the second seating surface 1282 becomes the third guide protrusion 1282a and a boundary between the upper end of the button ascending groove 1284 and the second seating surface 1282 becomes the fourth guide protrusion 1282b.

Further, at both sides of the second guide protrusion 1286, a first upper guide surface 1286a and a second upper guide surface 1286b have an upward convex shape, respectively, and accordingly, a boundary between the first upper guide surface 1286a and the second upper guide surface 1286b becomes the second guide protrusion 1286.

The first upper guide surface 1286a is continuously formed with the upper inner surface of the button descending groove 1283 and the second upper guide surface 1286b is continuously formed with the upper inner surface of the button ascending groove 1284.

Further, a contact center line C2 of the second seating surface 1282 and an apex of the second guide protrusion 1286 are not positioned on the same line based on the ascending direction of the button 1276, and the contact center line C2 of the second seating surface 1282 is separated from the apex of the second guide protrusion 1283 at one side (at a left side in the drawing).

Herein, the contact center line C2 of the second seating surface 1282 means a line that passes the center of the button support shaft 1277 in direction of ascending and descending of the button 1276 when the button supporting shaft 1277 is placed on the second seating surface 1282.

Further, a contact center line C3 of the first upper guide surface 1286a and an apex of the third guide protrusion 1282a are not positioned on the same line based on the ascending direction of the button 1276, and the contact center line C3 of the first upper guide surface 1286a is separated from the apex of the third guide protrusion 1282a at one side (at a left side in the drawing).

Herein, the contact center line C3 of the first upper guide surface 1286a means a line which passes the center of the button support shaft 1277 in direction of ascending and descending of the button 1276 when the button 1276 maximally descends by the user so that the upper surface of the button support shaft 1277 contacts the first upper guide surface 1286a while the button 1276 ascends, that is, the button support shaft 1277 is placed on the first seating surface 1281.

Further, a contact center line C4 of the second upper guide surface 1286b and an apex of the fourth guide protrusion 1282b are not positioned on the same line based on the ascending direction of the button 1276, and the contact center line C4 of the second upper guide surface 1286b is separated from the apex of the fourth guide protrusion 1282b at one side (at a left side in the drawing).

Herein, the contact center line C4 of the second upper guide surface 1286b means a line which passes the center of the button support shaft 1277 in direction of ascending and descending of the button 1276 when the button 1276 descends by the user so that the upper surface of the button support shaft 1277 contacts the second upper guide surface 1286b while the button 1276 ascends, that is, the button support shaft 1277 is placed on the second seating surface 1282.

In the tension control bar 127 according to the first embodiment of the present invention, a direction in which the first guide protrusion 1285 is spaced apart from the contact center line C1 of the first seating surface 1281, a direction in which the second guide protrusion 1286 is spaced apart from the contact center line C2 of the second seating surface 1282, a direction in which the third guide protrusion 1282a is spaced apart from the contact center line C3 of the first upper guide surface 1286a, and a direction in which the fourth guide protrusion 1282b is spaced apart from the contact center line C4 of the second upper guide surface 1286b are all the same as each other. Accordingly, whenever the user presses the button 1276, the button 1276 rotates in one direction due to the action of the button support shaft 1277 and the guide groove 128.

The principle of ascending and descending of the button 1276 having the guide groove 128 is as follows.

First, while the button 1276 is in ascending state, when the user pushes down the button 1276, the first upper guide surface 1286a descends to contact the upper surface of the button support shaft 1277, and when the center of the button support shaft 1277 coincides with the third contact center line C3, the button 1276 can no longer descend.

In this state, when the user removes the force applied to the button 1276, the button 1276 ascends again by the restoring force of the first and second springs 1273 and 1275 in the tension control bar 127. However, in this state, since the center of the button support shaft 1277 is positioned at the top of the second seating surface 1282 through the third guide protrusion 1282a, even though the button 1276 ascends, the button 1276 does not ascend at all because the second seating surface 1282 is engaged with the button support shaft 1277.

The button support shaft 1277 placed on the second seating surface 1282 stops in the contact center line C2 of the second seating surface 1282 and accordingly, the button 1276 maintains the descending state. As such, when the button 127 descends, the engaging member 1274 protrudes to the bottom of the tension control bar 127.

In this state, when the user presses the button 1276 again, as the second guide protrusion 1286 descends, the button support shaft 1277 placed on the second seating surface 1282 contacts the second upper guide surface 1286b and when the button 1276 descends and the center of the button support shaft 1277 coincides with the fourth contact center line C4, the button 1276 can not descend at all.

In this state, when the user removes the force applied to the button 1276, the button 1276 ascends again by the restoring force of the first and second springs 1273 and 1275 in the tension control bar 127. However, in this state, since the center of the button support shaft 1277 is positioned at the inlet of the button ascending groove 1284 through the fourth guide protrusion 1286b, while the button 1276 ascends and the button support shaft 1277 completely enters the button ascending groove 1284, the button 1276 continuously ascends.

The ascending button 1276 does not ascend at all and stops when the button support shaft 1277 reaches the first contact center line C1 of the first seating surface 1281, and in this case, the engaging member 1274 of the tension control bar 127 is returned to the inside of the body 1271.

FIG. 37 is an exploded perspective view of a tension control bar 127a according to a second embodiment of the present invention, and a shape of the guide groove 128 formed in the button 1276 is different from that of the first embodiment and other constitute elements are the same. Accordingly, hereinafter, the guide groove 128 of the tension control bar 127a according to the second embodiment of the present invention will be described.

The guide groove 128 of the tension control bar 127a according to the second embodiment of the present invention includes one button descending groove 1283 and one button ascending groove 1284. Further, the upper end of the button descending groove 1283 is connected to the upper end of the button ascending groove 1284 and the lower end of the button descending groove 1283 is connected to the lower end of the button ascending groove 1284, and thus the guide groove 128 has a closed-loop shape as a whole.

Further, at a portion where the lower end of the button descending groove 1283 is connected to the lower end of the button ascending groove 1284, a first seating surface 1281 on which the button support shaft 1277 is placed when the button 1276 ascends is concavely formed, and a sharp first guide protrusion 1285 protrudes toward the first seating surface 1281 at the top of the first seating surface 1281.

Particularly, a contact center line C1 of the first seating surface 1281 and an apex of the first guide protrusion 1285 are not positioned on the same line based on the ascending direction of the button 1285, and the contact center line C1 of the first seating surface 1281 is separated from the apex of the first guide protrusion 1285 at one side (at a right side in the drawing).

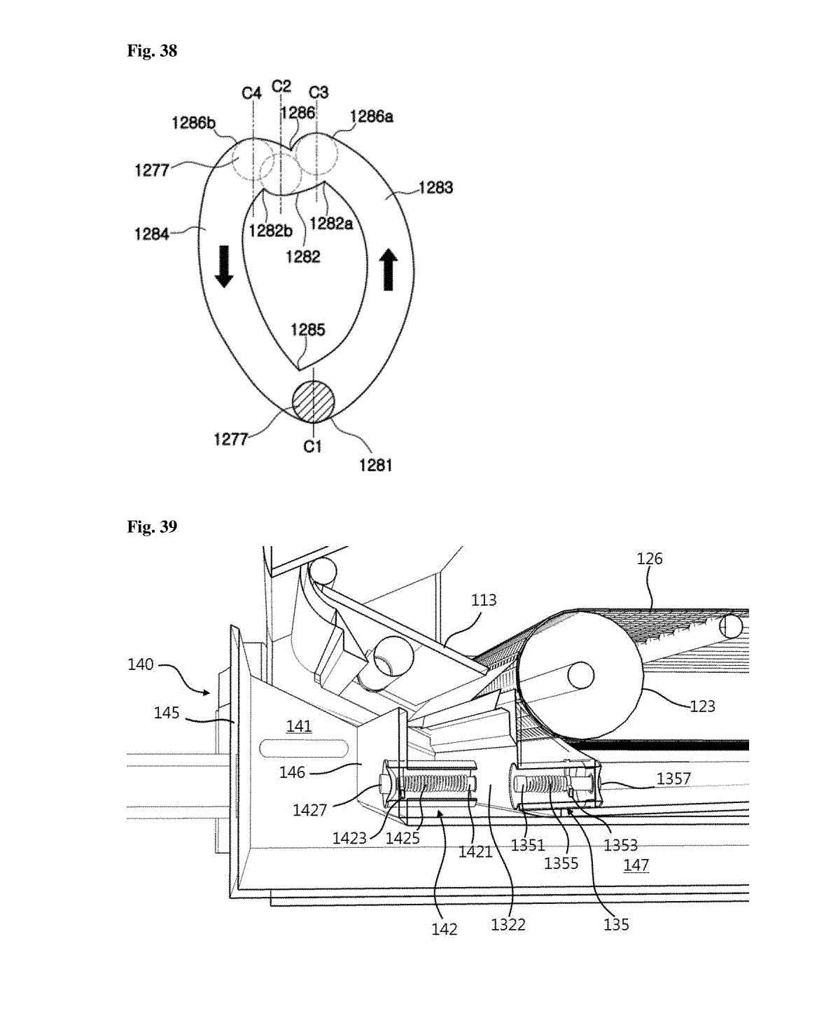

At a portion where the upper end of the button descending groove 1283 is connected to the upper end of the button ascending groove 1284, as illustrated in FIG. 38, when the button 1276 descends, a second seating surface 1282 on which the button support shaft 1277 is placed is concavely formed, and a sharp second guide protrusion 1286 protrudes toward the second seating surface 1282 at the top of the second seating surface 1282.

At both sides of the second seating surface 1282, a third guide protrusion 1282a and a fourth guide protrusion 1282b have an upwardly sharp shape, respectively. Accordingly, a boundary between the upper end of the button descending groove 1283 and the second seating surface 1282 becomes the third guide protrusion 1282a and a boundary between the upper end of the button ascending groove 1284 and the second seating surface 1282 becomes the fourth guide protrusion 1282b.

Further, at both sides of the second guide protrusion 1286, a first upper guide surface 1286a and a second upper guide surface 1286b have an upward convex shape, respectively, and accordingly, a boundary between the first upper guide surface 1286a and the second upper guide surface 1286b becomes the second guide protrusion 1286.

The first upper guide surface 1286a is continuously formed with the upper inner surface of the button descending groove 1283 and the second upper guide surface 1286b is continuously formed with the upper inner surface of the button ascending groove 1284.

Further, a contact center line C2 of the second seating surface 1282 and an apex of the second guide protrusion 1286 are not positioned on the same line based on the ascending direction of the button 1276, and the contact center line C2 of the second seating surface 1282 is separated from the apex of the second guide protrusion 1286 at the other side (at a left side in the drawing).

Further, a contact center line C3 of the first upper guide surface 1286a and an apex of the third guide protrusion 1282a are not positioned on the same line based on the ascending direction of the button 1276, and the contact center line C3 of the first upper guide surface 1286a is separated from the apex of the third guide protrusion 1282a at the other side (at a left side in the drawing).

Further, a contact center line C4 of the second upper guide surface 1286b and an apex of the fourth guide protrusion 1282b are not positioned on the same line based on the ascending direction of the button 1276, and the contact center line C4 of the second upper guide surface 1286b is separated from the apex of the fourth guide protrusion 1282b at one side (at a left side in the drawing).

As such, in the tension control bar 127 according to the second embodiment of the present invention, the contact center line C1 of the first seating surface 1281 is separated from the first guide protrusion 1285 at the right side in the drawing, while the contact center line C2 of the second seating surface 1282, the contact center line C3 of the first upper guide surface 1286a, and the contact center line C4 of the second upper guide surface 1286b are separated from the second guide protrusion 1286, the third guide protrusion 1282a, and the fourth guide protrusion 1282b at the left side in the drawing, respectively. Thus, the tension control bar 127 according to the second embodiment is different from the tension control bar 127 according to the first embodiment.

With this configuration, when the rotating direction ascends when the button 1276 descends, the rotating direction is opposite, and thus whenever the user presses the button 1276, the button 1276 reciprocates within a predetermined angle.

Meanwhile, as illustrated in FIGS. 1, 4, and 8, the isolation container unit 140 includes a storage space 147 storing excrement and water, and an inlet 141 which is opened upward and into which the excrement is injected is formed.

As illustrated in FIGS. 1 and 8, the inlet 141 is surrounded by an outer wall 145, an inner wall 146, and two side walls 148, and the outer wall 145, the inner wall 146, and the two side walls 148 all protrude above the upper surface of the storage space 147. A grip 143 is connected to the outside of the outer wall 145 and an inlet port 142 is connected to the inner wall 146.

The inlet port 142 is used as a passage which is connected to the drain port 135 installed in the water collecting wall 1322 of the bottom unit 130 to inject urine or water stored in the water collecting wall 1322 when the isolation container unit 140 is inserted to the receiving space 137 of the bottom unit 130.

As illustrated in FIG. 39, the drain port 135 of the bottom unit 130 includes a pipe installed by penetrating through the water collecting wall 1322, a shaft 1351 installed in a length direction in the pipe, a shaft support member 1353 supporting the shaft 1351 in the pipe, a cap 1357 connected to one end of the drain plate 132 of the shaft 1351 to open and close the pipe, and a spring 1355 installed between the other end of the shaft 1351 and the shaft support member 1353.

The spring 1355 provides restoring force in which the cap 1357 is pulled to the pipe, and accordingly, even though the isolation container unit 140 is separated from the bottom unit 130, the excrement or cleaning water is not leaked through the drain port 135.

The inlet port 142 of the isolation container unit 140 includes a pipe installed by penetrating through the inner wall 146 of the inlet 141, a shaft 1421 installed in a length direction in the pipe, a shaft support member 1423 supporting the shaft 1421 in the pipe, a cap 1427 connected to one end of the inlet 141 of the shaft 1421 to open and close the pipe, and a spring 1425 installed between the other end of the shaft 1421 and the shaft support member 1423.

The spring 1425 provides restoring force in which the cap 1427 is pulled to the pipe, and accordingly, even though the isolation container unit 140 is separated from the bottom unit 130, the internal waste is not leaked through the inlet port 142.

The pipe of the inlet port 142 protrudes outward the inner wall 146 and has a diameter smaller than that of the pipe of the drain port 135. Accordingly, when the isolation container unit 140 is inserted to the receiving space 137 of the bottom unit 130, the shaft 1421 of the inlet port 142 and the shaft 1351 of the drain port 135 push each other while the pipe of the inlet port 142 is inserted to the pipe of the drain port 135.

When the isolation container unit 140 is continuously pushed, while the shaft 1421 of the inlet port 142 and the shaft 1351 of the drain port 135 reversely push each other, the cap 1427 of the inlet port 142 and the cap 1357 of the drain port 135 are separated from the pipe to form a flow passage.

When the flow passage is formed, the excrement or cleaning water flowing through the drain plate 132 of the bottom unit 130 is injected to the storage space of the isolation container unit 140 through the inlet port 142.

In this state, when the isolation container unit 140 is separated from the bottom unit 130, the caps 1427 and 1357 are in close contact with the pipe by the springs 1425 and 1355 installed in the inlet port 142 and the drain port 135, respectively, to close the flow passage.

In the embodiment of the present invention, when the isolation container unit 140 is inserted to the receiving space 137 of the bottom unit 130, the pipe of the inlet port 142 is inserted into the pipe of the drain port 135, but is not necessarily limited thereto. Accordingly, the pipe of the drain port 135 may be configured to be inserted into the pipe of the inlet port 142.

Since the grip 143 is provided in the isolation container unit 140 removed from the bottom unit 130, the user holds the grip 143 and carries the isolation container unit 140 to discard the internal waste.

However, in the isolation container unit 140 removed from the bottom unit 130, since the inlet 141 is opened, the waste is slopping and spilled out during carrying or the grip 143 is missed and the waste may be spilled.

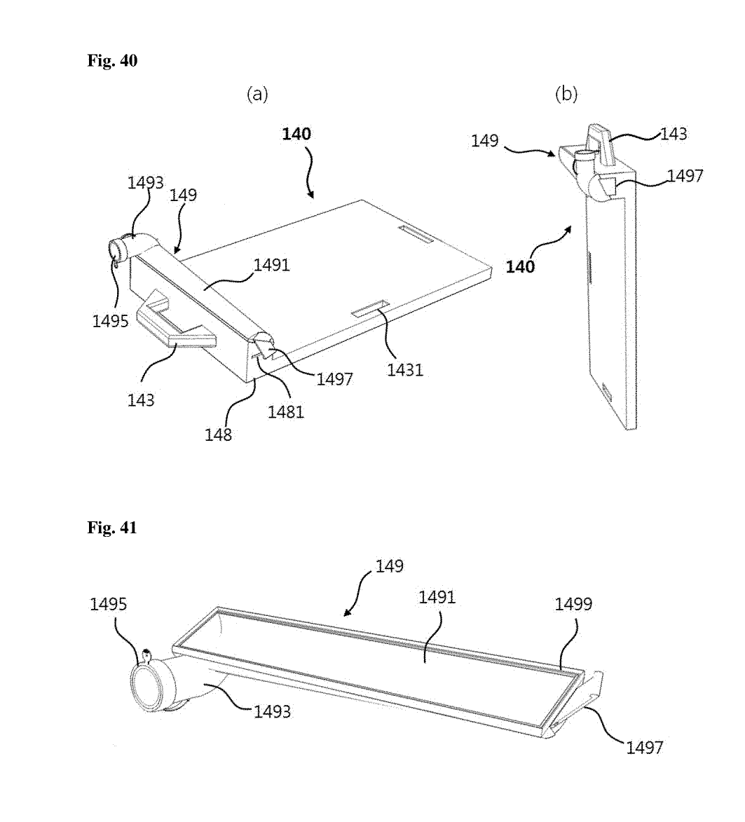

In order to prevent the risk, as illustrated in FIG. 40, it is preferred to install the isolation container cover 149 in the inlet 141 of the isolation container unit 140.

As illustrated in FIGS. 40 and 41, the isolation container cover 149 includes a cover portion 1491 having a size corresponding to the inlet 141, a plurality of connection members 1497 formed in the cover portion 149 for connecting the cover portion 1491 and the isolation container unit 140, an outlet 1493 protruding from one side of the cover portion 1491, and a cap 1495 installed in the entry of the outlet 1493.

In the embodiment of the present invention, isolation container cover connection grooves 1481 are formed on both side walls 148 of the inlet 141 and a connection member 1497 connected thereto is formed in the cover portion 1491. However, of course, the detailed shapes of the isolation container cover connection grooves 1481 and the connection member 1497 are not necessarily limited thereto.

It is preferred that a packing 1499 is installed at a portion contacting the edge of the inlet 141 on the inner side of the cover portion 1491. Further, in order to prevent a loss of the cap 1495, it is preferred that the cap 1495 and the cover portion 149 or the cap 1495 and the outlet 1493 are connected to each other by a flexible connection member.

Accordingly, the user may hold the grip 143 and stably carry the isolation container unit 140 while the isolation container cover 149 is installed in the isolation container unit 140 removed from the bottom unit 130, and while the cap 1495 is separated, the waste may be more stably removed through the outlet 1493.

Meanwhile, when the waste is discarded through the outlet 1493 of the isolation container cover 149, while internal pressure of the closed storage space 147 is smaller than air pressure, the waste may not be smoothly discharged, and when the elastic coefficient of the spring 1425 installed in the inlet port 142 is appropriately selected, the problem may be solved.

When the difference between the internal pressure of the storage space 147 and the air pressure is larger than the restoring force of the spring 1425, the cap 1427 is opened and air is injected to the inside of the storage space 147, and thus a pressure difference may be solved.

The urine guide unit 150 provides against a case where a male dog lifts leg and pees, and the urine guide unit 150 is disposed in a horizontal direction at the rear side of the net-type belt 126 and protrudes at a considerable height to the net-type belt 126.

As illustrated in FIG. 5, the lower end of the urine guide unit 150 is mounted on the edge cover 114 of the top unit 110 and the rear surface may be installed to contact the engine chamber cover 111.

The urine guide unit 150 may include a urination plate 151 formed in a concave curved surface and a water barrier plate that protrudes forward from both side ends in the horizontal direction of the urination plate 151 to prevent the urine from being spattered to the outside.

Meanwhile, when the pet dog urinates in the urination plate 151, it is necessary to clean the urination plate 151, and thus a means cleaning the urination plate 151 needs to be provided.

As an example, a nozzle is installed around the urination plate 151 and when the pet dog urinates, the water may be sprayed from the nozzle toward the urination plate 151. However, in the direct spraying method, it is not easy to spray the water to evenly flow down all over the urination plate 151 and the water may be spattered due to spraying pressure.

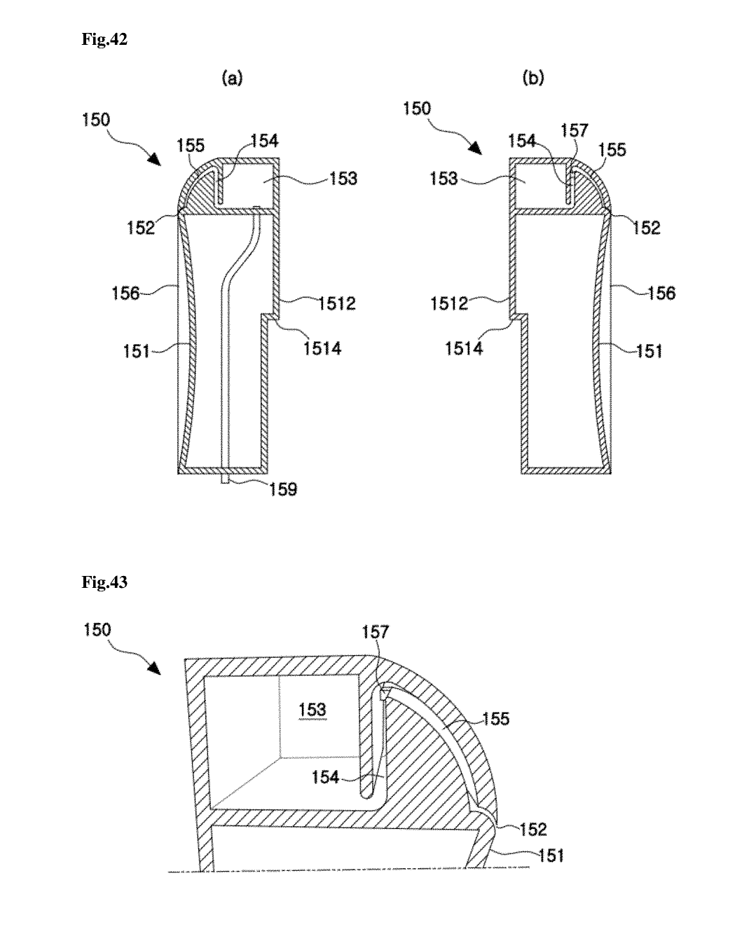

As another example, as illustrated in a cross-sectional view of FIG. 42, a water collecting portion 153 is formed in the urine guide unit 150 and water supplied to the water collecting portion 153 is discharged through a slit-shaped outlet 152 formed at the front upper end of the urination plate 151 to clean the urination plate 151. As such, when the water is discharged through the outlet 152 at the upper end of the urination plate 151, since the water is evenly dispersed on the entire surface of the urination plate 151 by adhesion and naturally flows down, there is no risk of water spattering and the urination plate 151 may be more easily cleaned.

FIG. 42A is a cross-sectional view of a direction viewed to the left side from a vertical cutout portion of the center of the urine guide unit 150 and FIG. 42B is a cross-sectional view of a direction viewed to the right side.

Referring to FIG. 42, in detail, at the inside of the urine guide unit 150, an inner space is formed between the front urination plate 151 and a rear plate 1512, and at the top of the inner space, the water collecting portion 153 partitioned from the lower space by a horizontal barrier in the horizontal direction is formed. In the rear plate 1512, a jaw 1514 mounted on the upper surface of the engine chamber cover 111 may be formed.

A water supply pipe 159 is installed inside the urine guide unit 150 and a lower end of the water supply pipe 159 protrudes to the outside of the urine guide unit 150 to be connected to a connector 1248 provided in the support frame 124 of the conveyor unit 120. The upper end of the water supply pipe 159 communicates with the inside of the water collecting portion 153.

Accordingly, the water supplied to the water collecting portion 153 through the water supply pipe 159 is discharged to the front surface of the urination plate 151 through the outlet 152 to clean the urination plate 151.

Meanwhile, the embodiment of the present invention is characterized in that a Siphon principle is applied to the urine guide unit 150 so that water is discharged to the outlet 152 only when water at a predetermined level or more is supplied to the water collecting portion 153.

Particularly, an ascending passage 154 is formed at one side of the water collecting portion 153. And the upper end of the ascending passage 154 and the outlet 152 are connected by a descending passage 155. In this case, the upper end of the ascending passage 154 needs to be positioned above the outlet 152 and an air hole 158 communicating with the outside needs to be formed at the ceiling of the water collecting portion 153 so that air pressure may be applied to the water collecting portion 153.

As such, before the water is filled to the upper end of the ascending passage 154, the water is not discharged to the outlet 152. But once the water is filled, the water starts to be discharged through the descending passage 155 due to the Siphon principle, and then the water of the water collecting portion 153 is continuously discharged until the lower inlet of the ascending passage 154 is exposed.

When such a principle is applied, it is not required to separately install a device that opens and closes the outlet 152, and the control device needs to quantitatively supply to the water collecting portion 153 the water enough to be filled to the upper end of the ascending passage 154.

The shapes of the outlet 152, the ascending passage 154, the descending passage 155, and the like are not limited to those illustrated in the drawing and may be modified in various forms in detailed applications.

Meanwhile, even though the water in the water collecting portion 153 is continuously discharged by the Siphon principle, when the inlet of the lower end of the ascending passage 154 is exposed, the water is no longer discharged and then a small amount of water always remains at the bottom of the water collecting portion 153.

However, in this state, like FIG. 13, when the toilet 100 for pet dogs is erected, the water collected downward may be discharged through the outlet 152.

In order to prevent the risk, as illustrated in FIGS. 42B and 43, a water barrier wall 157 may be formed at one side of the inner passage of the urine guide unit 150.

In the embodiment of the present invention, the water barrier wall 157 having a predetermined length is formed in a horizontal direction from the right end of the ascending passage 154 of the urine guide unit 150. The water barrier wall 157 may also be formed in the descending passage 155.

As such, when the water barrier wall 157 is formed at the right end of the ascending passage 154 or the descending passage 155, as illustrated in FIG. 13, even though the water in the water collecting portion 153 is collected downward by erecting the toilet 100 for pet dogs, the water is blocked by the water barrier wall 157 and then is not leaked to the outlet 152.

Hereinafter, an operation of the toilet 100 for pet dogs according to the embodiment of the present invention having the aforementioned configuration will be described.

First, when describing an assembling process, the conveyor unit 120 is placed on the conveyor mounting plate 136 of the bottom unit 130, the top unit 110 is connected to the top thereof, and a hook 119 provided on the top unit 110 is engaged and fixed to the hook jaw 139 of the bottom unit 130.

Subsequently, the isolation container unit 140 is inserted through the left inlet 12 of the top unit 110 to be pushed to the receiving space 137 of the bottom unit 130 and engaging protrusions 1172 of the isolation container locking member 117 provided at both sides of the inlet 12 of the top unit 110 are inserted to the engaging groove 138 of the bottom unit 130 to support the both sides of the outer wall 145 of the isolation container unit 140.

In this process, when the drain port 135 provided in the bottom unit 130 and the inlet port 142 of the isolation container unit 140 are connected to each other, a flow passage is formed between the top of the drain plate 132 and the storage space 147 of the isolation container unit 140.

In the assembled state, when the pet dog ascends on the net-type belt 126, the control device (not illustrated) detects the pet dog through the detection sensor 116 and starts to counting, and after a predetermined time elapses, if the pet dog is no longer detected through the detection sensor 116, it is determined that the pet dog excretes.

If it is determined that the pet dog excretes, the control device controls a cover driving means to rotate the isolation container cover 113 and expose the inlet 141.

Next, the driving roller 121 and the cleaning roller 122 rotate by controlling the roller driving means, and while the net-type belt 126 moves to the left side from the top of the load supporter 125 as the driving roller 121 rotates, the excrement placed on the net-type belt 126 is injected to the inlet 141. In this case, the blade of the funnel 134 installed around the inlet 141 separates the excrement residue clearly from the net-type belt 126.

Meanwhile, when the driving roller 121 and the cleaning roller 122 rotate, the control device controls the pump to spray the water between the cleaning roller 122 and the net-type belt 126 through the nozzle 192 of the cleaning chamber and simultaneously inject the water between the driven roller 123 and the net-type belt 126 through the nozzle 1256 provided in the outermost vertical rib 1252 of the load supporter 125.

In addition, when the net-type belt 126 reaches the top of the drain plate 132 by rotating halfway, the water spraying through the nozzle 1256 provided in the outermost vertical rib 1252 stops and the water is injected for a moment through the nozzle 1256 provided in other vertical ribs 1252. Even in this case, the nozzle 192 of the cleaning chamber may continuously spray the water.

Next, when the net-type belt 126 rotates one full turn to reach an original position, the water supply to the nozzle 192 of the cleaning chamber stops. Even though the water supply to the nozzle 192 stops, the remaining cleaning water on the net-type belt 126 may be removed by the brush of the cleaning roller 122 by continuously rotating the driving roller 121 and the cleaning roller 122.

The nozzle 190 installed at both sides of the water collecting wall 1322 cleans the bottom of the conveyor mounting plate 136. A spraying time of the nozzle 190 is not particularly limited, and the water may be sprayed in an early stage when the driving roller 121 operates, the water may be sprayed after the net-type belt 126 rotates a half turn, or the water may be sprayed after the water of the net-type belt 126 is removed by operating the cleaning roller 122 without water spraying of the nozzle 192 after the net-type belt 126 rotates one turn.

Meanwhile, the isolation container cover 113 may be opened while the net-type belt 126 rotates approximately one turn even after the excrement drops to the inlet 141. When the net-type belt 126 rotates a half turn, water spraying in the nozzle 1256 provided in the outermost vertical rib 1252 of the load supporter stops, but the water spraying for cleaning the load supporter 125 is performed in other vertical ribs 1252, and in this process, the water agglomerated in the hole of the net-type belt 126 may be injected to the inlet through the funnel 134.

The water sprayed in the cleaning process flows down along the drain plate 132 to be collected at one side of the water collecting wall 1322 and then flows into the isolation container unit 140 through the drain port 135 of the bottom unit 130 and the inlet port 142 of the isolation container unit 140.

Meanwhile, the control device operates the fan 170 mounted at the outside of the cleaning chamber cover 112 after the cleaning process to forcibly dry the inside of the toilet 100 for pet dogs.

Further, the sterilizing lamp 180 installed in the isolation container cover 113 is continuously or periodically turned on to prevent germs from being propagated in the isolation container unit 140 or to prevent odor from being generated.

Further, the sterilizing lamp 182 installed in the water collecting wall 1322 is turned on to prevent germs from being propagated at the upper surface and the periphery of the drain plate 132 or to prevent odor from being generated.

Meanwhile, if it is determined that the pet dog urinates in the urination plate 151 of the urine guide unit 150, the control device controls the pump 1314 to supply a predetermined amount of water to the water collecting portion 153 through the water supply pipe 159, and when the water is filled up to the upper end of the ascending passage 154, most of water is discharged through the outlet 152 by the Siphon principle to clean the urination plate 151.

The cleaning water of the urination plate 151 flows into the drain plate 132 through the net-type belt 126 and then flows into the isolation container unit 140 through the drain port 135.

In order for the control device to determine that the pet dog urinates in the urination plate 151 of the urine guide unit 150, the urination plate 151, the water barrier plate 156, or a urine detection means therearound may be separately installed.

While the exemplary embodiments of the present invention have been illustrated and described above, the present invention is not limited to the aforementioned specific exemplary embodiments, various modifications may be made by a person with ordinary skill in the art to which the present invention pertains without departing from the subject matters of the present invention that are claimed in the claims, and these modifications should not be appreciated individually from the technical spirit or prospect of the present invention.

1. A toilet for pet dogs comprising:
a bottom unit having a receiving space opened to one side and formed between the bottom and a drain plate;
an isolation container unit which is inserted to the receiving space and has a storage space and an inlet opened upward;
a conveyor unit installed on the drain plate of the bottom unit, wherein the conveyor unit has a net-type belt on which the pet dog rides, a driving roller and a driven roller on which the net-type belt is wound, and a cleaning roller installed at one side of the driving roller to clean the net-type belt; and
a top unit mounted on the bottom unit to expose the net-type belt, wherein the top unit has a opening portion to expose the net-type belt, a cleaning chamber cover positioned at the top of the cleaning roller, a nozzle installed at the ceiling of the cleaning chamber cover to spray water, and a fan supplying air to an inner space of the cleaning chamber cover for forcible drying.

2. The toilet for pet dogs of claim 1, wherein the top unit includes an isolation container cover opening and closing the inlet of the isolation container unit and a sterilizing lamp installed in the isolation container cover.

3. The toilet for pet dogs of claim 1, wherein the bottom unit includes a water collecting wall formed at one side of the drain plate and the water collecting wall includes a curved portion surrounding one side of the driven roller and having same curvature of the driven roller.

4. The toilet for pet dogs of claim 1, wherein the bottom unit includes conveyor mounting plates that protrudes toward the upside of the drain plate at inner walls facing each other with the drain plate interposed therebetween, respectively, and a nozzle that sprays water to the bottom of the conveyor mounting plate.

5. The toilet for pet dogs of claim 1, wherein the bottom unit includes a water collecting wall formed at one side of the drain plate and the water collecting wall has a sterilizing lamp that irradiates light to the upside of the drain plate.

6. The toilet for pet dogs of claim 1, wherein the conveyor unit includes a load supporter supporting the net-type belt and a load supporter cleaning means cleaning the load supporter.

7. The toilet for pet dogs of claim 6, wherein the load supporter includes a plurality of vertical ribs and a plurality of horizontal ribs mounted on the plurality of vertical ribs, and the load supporter cleaning means includes a water supply means supplying water to the inside of the vertical ribs,
and wherein a load supporter cleaning nozzle is formed at a position where each vertical rib crosses the horizontal rib to spray the water to the bottom of the horizontal rib.

8. The toilet for pet dogs of claim 6, wherein the load supporter includes a plurality of vertical ribs and a plurality of horizontal ribs connected to the plurality of vertical ribs, and the load supporter cleaning means includes a plurality of water supply pipes installed in the same direction as the plurality of vertical ribs at the bottom of the plurality of horizontal ribs,
and wherein a load supporter cleaning nozzle is formed at a position where each water supply pipe crosses the horizontal rib to spray the water to the bottom of the horizontal rib.

9. The toilet for pet dogs of claim 7, wherein the load supporter cleaning nozzle is formed at the bottom of the central axis of the horizontal rib at the bottom of the horizontal rib to spray the water toward an outer circumference of the horizontal rib.

10. The toilet for pet dogs of claim 1, wherein the conveyor unit includes a load supporter supporting the net-type belt and a nozzle installed in the load supporter to spray water between the driven roller and the net-type belt.

11. The toilet for pet dogs of claim 1, wherein a urine guide unit is formed to protrude upward at one side of the opening portion of the top unit.

12. The toilet for pet dogs of claim 11, wherein the urine guide unit includes a water collecting portion in which the water supplied from the water supply pipe is collected, a urination plate formed toward the net-type belt at one side, water barrier plates formed at both sides of the urination plate and protruding forward the urination plate, and an outlet formed in the urination plate to discharge water of the water collecting portion.

13. The toilet for pet dogs of claim 12, wherein the urine guide unit includes an ascending passage of which a lower end communicates with the water collecting portion and an upper end is positioned above the outlet and a descending passage connecting the upper end of the ascending passage and the outlet, and the water of the water collecting portion is discharged to the urination plate by a Siphon principle.

14. The toilet for pet dogs of claim 13, wherein in at least one of the ascending passage or the descending passage, a water barrier wall connected to one side of the urine guide unit is formed.

15. A toilet for pet dogs comprising:
a bottom unit having a receiving space opened to one side and formed between the bottom and a drain plate;
an isolation container unit which is inserted to the receiving space and has a storage space and an inlet opened upward;
a conveyor unit installed on the drain plate of the bottom unit and having a net-type belt on which the pet dog rides; and
a top unit mounted on the bottom unit to expose the net-type belt, wherein the top unit has an inlet for entrance of the isolation container unit at one side and a pair of isolation container locking members installed rotatably based on vertical shafts at both sides of the inlet.

16. The toilet for pet dogs of claim 15, wherein the pair of isolation container locking members includes connection means which are formed at the inner side adjacent to the vertical shaft, respectively, to be connected to the inner wall of the bottom unit.

17. The toilet for pet dogs of claim 15, wherein the toilet for pet dogs comprises a pair of side cover one end of which is connected to the pair of the isolation container locking members, respectively, and each side cover includes a cutout portion formed in a horizontal direction from the other end and a grip portion which protrudes from the outside of the side cover to the outside of the cutout portion and has a receiving groove to which a grip of the isolation container unit is inserted at the inner side.

18. The toilet for pet dogs of claim 15, wherein in the pair of isolation container locking members, a separation prevention projection is formed at the edge of the inner side positioned at the opposite side to the vertical shaft, and the separation prevention projection is inserted between an inner wall of the bottom unit and an outer wall of the isolation container unit when the isolation container locking member is connected to the inner wall of the bottom unit.

19. The toilet for pet dogs of claim 15, wherein the pair of isolation container locking members includes stoppers protruding downward at the outer side adjacent to the vertical shaft, respectively, and the stopper is in contact with the outer end of the bottom of the bottom unit when the isolation container locking member is connected to the inner wall of the bottom unit.

20. The toilet for pet dogs of claim 15, wherein the pair of isolation container locking members includes stoppers protruding to be adjacent to the vertical shaft at the inner side, respectively, and the stopper is in contact with the outer end of the bottom unit when the isolation container locking member is connected to the inner wall of the bottom unit.

21. The toilet for pet dogs of claim 15, wherein at the upper one side of the bottom unit, a bottom unit inlet is formed at a position corresponding to the inlet of the isolation container unit,
and wherein the bottom unit inlet is surrounded by a pair of partitions disposed in a horizontal direction to protrude upward at facing inner walls of the bottom unit, a support portion installed between the pair of partitions at one side of the bottom unit, and a water collecting wall formed in a vertical direction at one side of the drain plate.

22. The toilet for pet dogs of claim 21, wherein the top unit includes an isolation container cover to open and close the bottom unit inlet and shaft mounting grooves formed at the upper ends of the pair of partitions, wherein a cover rotation shaft connected to the isolation container cover is inserted to the shaft mounting grooves.

23. The toilet for pet dogs of claim 22, wherein the top unit includes a protection cover installed on the isolation container cover and the upper ends of the pair of partitions are in close contact with the lower surface of the protection cover in the top unit, respectively, and the upper end of the support portion is in close contact with the lower end of the protection cover.

24. The toilet for pet dogs of claim 21, wherein the support portion includes an inclined surface decreased toward the bottom unit inlet.

25. The toilet for pet dogs of claim 21, wherein the bottom unit includes a funnel installed at the top of the bottom unit inlet, the funnel includes a opening portion corresponding to the bottom unit inlet and frames surrounding the opening portion, and the height of the upper surface of the frames decreases toward the opening portion,
and wherein, in the frames, a first vertical frame is mounted on the upper end of the water collecting wall formed in a vertical direction at one side of the drain plate and a second vertical frame is in contact with the inner side of the support portion.

26. The toilet for pet dogs of claim 25, wherein the water collecting wall includes a curved portion which is formed with the same curvature as the roller on which the net-type belt is wound to closely surround one side of the roller,
wherein, at the outer side of the first vertical frame, a roller facing surface which is formed with the same curvature as the curved portion of the water collecting wall to closely surround one side of the roller from the upper end of the curved portion of the water collecting wall is formed and a sharp blade is formed on the upper end of the roller facing surface.

27. The toilet for pet dogs of claim 25, wherein on the lower surface of the first vertical frame, an upward inclined surface in which one end is connected to the inner end of the upper surface of the frame is formed.

28. The toilet for pet dogs of claim 25, wherein on the lower surface of the first vertical frame, an inner wall connection groove to which the inner wall surrounding the inlet of the isolation container unit is inserted is formed, on the lower surface of the second vertical frame, an outer wall connection groove to which the outer wall surrounding the inlet of the isolation container unit is inserted is formed, and on the lower surfaces of the first horizontal frame and the second horizontal frame of the frames, side wall connection grooves to which a pair of side walls surrounding the inlet of the isolation container unit is inserted are formed, respectively.

29. The toilet for pet dogs of claim 28, wherein a projection is formed at the front end of the inner wall connection groove.

30. The toilet for pet dogs of claim 15, wherein the bottom unit includes a drain port including a first pipe installed by penetrating through the water collecting wall formed at one side of the drain plate, a first shaft supported by a first shaft support member in the first pipe, a first cap connected to one end of the first shaft to open and close the first pipe, and a first spring providing restoring forces in a closing direction to the first cap,
the isolation container unit includes an inlet port including a second pipe installed by penetrating through one side wall surrounding the inlet and having a different diameter from the first pipe, a second shaft supported by a second shaft support member in the second pipe, a second cap connected to one end of the second shaft to open and close the second pipe, and a second spring providing restoring force in a closing direction to the second cap, and
when the isolation container unit is inserted to the receiving space of the bottom unit, while the other end of the first shaft is in contact with the other end of the second shaft, the first cap and the second cap are separated from the pipes to form a flow passage.

31. The toilet for pet dogs of claim 15, further comprising:
a connection detecting means that is installed in the bottom unit to detect whether the isolation container unit is assembled or disassembled.

32. The toilet for pet dogs of claim 15, wherein a plurality of wheels is mounted on the other side of the bottom unit and a support portion having the same height as the plurality of wheels protrudes at the top unit.

33. The toilet for pet dogs of claim 15, further comprising:
an isolation container cover which is connected to the inlet of the isolation container unit when the isolation container unit is separated from the bottom unit,
wherein the isolation container cover includes a cover portion having a size corresponding to the inlet, a connection member connecting the cover portion and the isolation container unit, an outlet protruding from one side of the cover portion, and a cap mounted on the outlet.

34. The toilet for pet dogs of claim 15, wherein the conveyor unit includes
a driving roller and a driven roller on which the net-type belt is wound;
a support frame including a vertical frame disposed at one side of the driving roller and a horizontal frame having an inner space and a bearing housing insertion hole communicating with the inner space;
a bearing housing installed in the inner space and connected to a roller shaft of the driven roller;
a shaft insertion hole which is a portion through which the roller shaft of the driven roller passes and formed downward from upper end of the inner wall of the horizontal frame and then extended in a horizontal direction;
a fixing member fixed to the horizontal frame in the inner space;
a tension control bar which is installed between the bearing housing and the fixing member and has an engaging member selectively protruding to the lower surface;
an engaging groove which is a portion to which the engaging member of the tension control bar is inserted and formed on the bottom of the inner space; and
an elastic means installed between one side of the tension control bar and the fixing member.

35. The toilet for pet dogs of claim 15, wherein the tension control bar includes
a body having a penetrating portion and having a spring jaw formed at the inside of the penetrating portion;
a first spring mounted on the spring jaw;
an engaging member having a head having a larger diameter than that of the first spring and penetrating through the first spring;
a second spring installed at the top of the head of the engaging member;
a button installed at the top of the second spring;
a guide groove which is formed on an outer circumference of the button and includes a button ascending groove, a button descending groove, a first seating surface formed concavely downward from a connection portion between the lower end of the button descending groove and the lower end of the button ascending groove, a second seating surface formed concavely downward from a connection portion between the upper end of the button descending groove and the upper end of the button ascending groove, a first guide protrusion protruding toward the first seating surface from the top of the first seating surface, and second guide protrusion which protrudes toward the second seating surface from the top of the second seating surface and is formed between a first upper guide surface connected to the inner wall of the button descending groove and a second upper guide surface connected to the inner wall of the button ascending groove; and
a button support shaft of which one end is inserted to the guide groove by passing through one side of the body and which is alternately placed on the first seating surface and the second seating surface whenever the button is pressed.

36. The toilet for pet dogs of claim 35, wherein the second spring has an elastic coefficient larger than that of the first spring.

37. The toilet for pet dogs of claim 35, wherein the button ascending groove and the button descending groove have slopes opposite to each other based on an ascending direction of the button, and the plurality of button ascending grooves and the plurality of button descending grooves are alternately formed along the outer circumference of the button.

38. The toilet for pet dogs of claim 37, wherein a first contact center line passing through the center of the button support shaft along the up-and-down direction of the button is spaced apart from the first guide protrusion in a first direction when the button support shaft is placed on the first seating surface,
a second contact center line passing through the center of the button support shaft along the up-and-down direction of the button is spaced apart from the second guide protrusion in the first direction when the button support shaft is placed on the second seating surface,
a third contact center line passing through the center of the button support shaft along the up-and-down direction of the button is spaced apart from the third guide protrusion formed between the button descending groove and the second seating surface in the first direction when the button support shaft is placed on the first upper guide surface, and
a fourth contact center line passing through the center of the button support shaft along the up-and-down direction of the button is spaced apart from the fourth guide protrusion formed between the button ascending groove and the second seating surface in the first direction when the button support shaft is placed on the second upper guide surface.

39. The toilet for pet dogs of claim 35, wherein the guide groove forms a closed loop in which the upper end of the button descending groove is connected to the upper end of the button ascending groove and the lower end of the button descending groove is connected to the lower end of the button ascending groove.

40. The toilet for pet dogs of claim 39, wherein a first contact center line passing through the center of the button support shaft along the up-and-down direction of the button is spaced apart from the first guide protrusion in a first direction when the button support shaft is placed on the first seating surface,
a second contact center line passing through the center of the button support shaft along the up-and-down direction of the button is spaced apart from the second guide protrusion in a second direction opposite to the first direction when the button support shaft is placed on the second seating surface,
a third contact center line passing through the center of the button support shaft along the up-and-down direction of the button is spaced apart from the third guide protrusion formed between the button descending groove and the second seating surface in a second direction when the button support shaft is placed on the first upper guide surface, and
a fourth contact center line passing through the center of the button support shaft along the up-and-down direction of the button is spaced apart from the fourth guide protrusion formed between the button ascending groove and the second seating surface in the second direction when the button support shaft is placed on the second upper guide surface.
